(19) United States
(12) Patent Application Publication
(10) Pub. No.: US 2022/0382514 A1
(43) Pub. Date: Dec. 1, 2022

(54) CONTROL LOGIC FOR CONFIGURABLE AND SCALABLE MULTI-PRECISION OPERATION

(71) Applicant: Intel Corporation, Santa Clara, CA (US)

(72) Inventors: Kamlesh Pillai, Bangalore (IN); Gurpreet Singh Kalsi, Portland, OR (US); Sreedevi Ambika, Bangalore (IN); Om Omer, Bangalore (IN); Sreenivas Subramoney, Bangalore (IN)

(21) Appl. No.: 17/832,999

(22) Filed: Jun. 6, 2022

(51) Int. Cl. G06F 7/544

(52) U.S. Cl. CPC G06F 7/544

(57) ABSTRACT

Systems, apparatuses, and methods include technology that determines whether an operation is a floating-point based computation or an integer-based computation. When the operation is the floating-point based computation, the technology generates a map of the operation to integer-based compute engines to control the integer-based compute engines to execute the floating-point based computation. When the operation is the integer-based computation, the technology controls the integer-based compute engines to execute the integer-based computation.

### TECHNICAL FIELD

Embodiments generally relate to a flexible controller that is operable with various hardware architectures. More particularly, embodiments relate to a controller that is able to execute various floating-point (FP) and integer based operations with a same hardware architecture (e.g., integer-based compute engines).

### BACKGROUND

Deep Neural Networks (DNN) may include numerous multiply and accumulate (MAC) operations associated with matrix multiplication/convolution operations. The input precision (e.g., float32, into, int8, int16, float8, bfloat16, fp16 etc.) required for different processes depends on different factors (e.g., use cases). Some workloads may require FP support with float8, bfloat16 and fp16 (i.e., half precision). Single precision FP number (fp32) may be used predominantly during training of a DNN. Supporting such a variety of precisions may increase area, cost and number of hardware compute engines that are implemented in an accelerator. Alternatively, only a few precisions may be supported, but doing so may incur performance penalties and applicability. Either option may impact the overall accelerator power, performance and area matrices.

### BRIEF DESCRIPTION OF THE DRAWINGS

The various advantages of the embodiments will become apparent to one skilled in the art by reading the following specification and appended claims, and by referencing the following drawings, in which:

FIG. 1 is an example of an enhanced, multiformat control process according to an embodiment;

FIG. 2 is a flowchart of an example of a method of controlling compute engines to execute FP operations according to an embodiment;

FIG. 3 is a block diagram of an example of a multiformat architecture according to an embodiment;

FIG. 4 is an example of a decomposition and segregation process according to an embodiment;

FIG. 5 is an example of a mapping process to store input data, weights and output data according to an embodiment;

FIG. 6 is a block diagram of an example of a multiformat processing architecture according to an embodiment;

FIG. 7 is a block diagram of an example of a DNN architecture according to an embodiment;

FIG. 8 is a block diagram of an example of a systolic multiformat processing architecture according to an embodiment;

FIG. 9 is a block diagram of an example of scaling of multiformat controllers according to an embodiment;

FIG. 10 is a diagram of an example of different formats for FP numbers according to an embodiment;

FIG. 11 is a block diagram of an example of a Light-weight Compute Engine according to an embodiment;

FIG. 12 is a block diagram of an example of partial reduction architectures according to an embodiment;

FIG. 13 is a block diagram of an example of a quantization process according to an embodiment;

FIG. 14 is a block diagram of an example of an activation pipeline according to an embodiment;

FIG. 15A is a block diagram of an example of a Max Pooling pipeline according to an embodiment;

FIG. 15B is a block diagram of an example of a Max Pooling process according to an embodiment;

FIG. 16 is a block diagram of an example of an efficiency-enhanced and performance-enhanced training and inference computing system according to an embodiment;

FIG. 17 is an illustration of an example of a semiconductor apparatus according to an embodiment;

FIG. 18 is a block diagram of an example of a processor according to an embodiment; and

FIG. 19 is a block diagram of an example of a multi-processor based computing system according to an embodiment.

### DESCRIPTION OF EMBODIMENTS

Embodiments relate to machine learning applications (e.g., DNNs), that incorporate a hardware, Light-weight Compute Engine (LCE) comprising an enhanced multiformat controller and compute engines. The LCE supports multiple precisions with increased hardware utilization as well as with a reduced overall area relative to other designs. The compute engines (e.g., general-purpose multiply-accumulate (MAC) engines) are maintained in a streamlined fashion such that the compute engines consume reduced area and provide a platform to enable increased hardware efficiency and area benefits. Embodiments also support non-MAC operations without added hardware cost by executing on existing general-purpose compute engines.

Embodiments also relate to a set of configuration registers with programmable operational code (opcode) to provide support for a wide variety of operations (e.g. Convolution, Max pooling, Activation function, Partial reduction, etc.) across different numeric precisions (e.g., int4, int8, int16, Float8, bf16, fp16 etc.) using a single control section (e.g., only one multiformat controller with different functionalities across different precisions). The compute engines are streamlined due to a multiformat controller that is able to behave similarly to a plug-and-play unit to support various compute engines. The multiformat controller includes input read logic and control finite state machines (FSMs) to control and maintain a proper data flow into the compute blocks to execute the aforementioned aspects. The multiformat controller is a flexible design that is scalable for any number of compute units operating in parallel. The multiformat controller also supports various numeric precisions, such that compute engines perform a same multiply and accumulate operations irrespective of the numeric precision of a current operation associated with the compute engines. The multiformat controller manages data manipulation, reordering etc. to execute the above operations.

Therefore, embodiments herein provide a significant amount of flexibility, configurability and programmability to support all major operations involved in the DNN workload. Indeed, embodiments efficiently utilize hardware while supporting different numeric precisions and operations, due to data reordering and manipulation logic in the multiformat controller. Thus, embodiments herein provide significant enhancements in terms of power, performance efficiency, hardware efficiency and applicability relative to conventional designs.

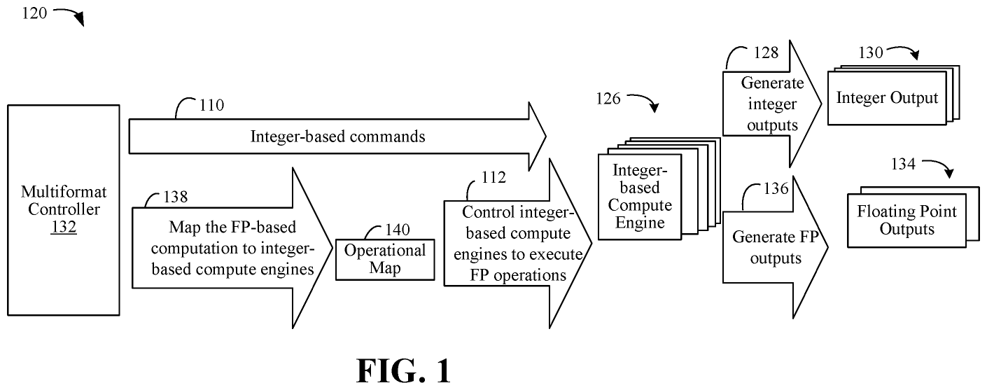

Turning to FIG. 1, an enhanced, multiformat control process 120 is illustrated. A multiformat controller 132 controls both FP and integer operations of varying precisions. In particular, the multiformat controller 132 is configured to issue integer-based commands and FP commands. That is, the multiformat controller 132 is able to receive operations in FP and integer formats, and execute the operations with the integer-based compute engines 126. In this example, the multiformat controller 132 directly issues integer-based commands 110 to the integer-based compute engines 126, however it will be understood that in some examples the integer-based commands 110 may be omitted and an integer controller (which handles only integer operations) may issue integer-based commands. As explained below, in this example the multiformat controller 132 may control the integer-based compute engines 126 to execute both integer-based operations and FP-based operations. In some examples, FP-based compute engines may be included in addition to the integer-based compute engine 126. To reduce area, embodiments herein include configurable integer-based compute engine 126 which can perform integer and FP operations within an integer pipeline. That is, since the integer-based compute engines 126 are much lighter (in terms of area and power) than FP-based compute engines, embodiments execute operations with the integer-based compute engine 126 and perform FP operations using the integer-based compute engine 126 to reduce reliance on FP-based compute engines and increased size due to the inclusion of further FP-based compute engine.

In order to execute an FP based computation, the multiformat controller 132 may adjust the computation to execute FP operations (e.g., operations of a DNN workload) on the integer-based compute engines 126. For example, the multiformat controller 132 maps the FP-based computation to the integer-based compute engines 126, 138 to generate the operational map. For example, the multiformat controller 132 may divide a floating-point number associated with the FP based computation into a plurality of portions, and assign each of the plurality of portions to a different compute engine of the integer-based compute engines 126. The plurality of portions includes a sign portion, an exponent portion and a mantissa portion, and the multiformat controller 132 stores the sign portion into a sign register, the exponent portion into an exponent register and the mantissa portion into a mantissa register to facilitate proper data flow and provisioning to the integer-based compute engines 126. In some embodiments, the multiformat controller 132 identifies weight data associated with the operation, where the weight data has a first number of dimensions. The multiformat controller 132 adjusts the weight data to increase the first number of dimensions to a second number of dimensions, stores the weight data having the second number of dimensions in a tile-based fashion to a memory and stores input features and output features generated by the integer-based compute engines 126 to the memory in the tile-based fashion. Doing so stores data efficiently in the memory while maintaining the data in an execution order associated with the integer-based compute engines 112.

The operational map 140 further includes a finite state machine that includes a counter, and the multiformat controller 132 further comprises controlling a flow of data to the integer-based compute engines 126 based on the finite state machine, where the data is associated with the operation. The finite state machine may be used to execute pooling, quantization and activation operations. The finite state machine may also include a counter based finite state machine logic with horizontal and vertical walk reused as configured for different filter sizes, strides, and other convolutional operations eliminating the need to replicate aspects of the control logic. The finite state machine may be reused for pooling, quantization and activation operations to enable a wider support for deep neural network operations without increased area. The operational map 140 further includes an assignment of sign elements of first and second floating-point numbers associated with the FP-based computation to an XOR gate of the integer-based compute engines 126, an assignment of exponent elements of the first and second floating-point numbers to an adder of the integer-based compute engines 126, and an assignment of mantissa elements of the first and second floating-point numbers to a multiplier of the integer-based compute engines 126. The respective gates will execute assigned operations under the control of the multiformat controller 132.

The operational map 140 may include a mapping of the various portions of the FP-based computation and/or the data associated with the FP-based computation to the integer-based compute engines 126, and additionally instructions on how to combine the outputs together to generate the final output. Thus, the multiformat controller 132 may decompose FP-based computations into several constituent components to operate on the integer-based compute engines 126, and issue commands to the integer-based compute engines 126 based on the operational map 140 and/or to implement the operational flow described in the operational map 140. In some embodiments, the multiformat controller 132 may further translate FP-based commands into integer-based commands to ensure compatibility with the integer-based compute engine 126. For example, the multiformat controller 132 may issue commands to the different components of the integer-based computer engines 126, which will process the portions off the FP data, to integer-based commands that are compatible with the architecture of the integer-based compute engines 126. Thus, the multiformat controller 132 may adjust a command structure associated with the FP-based computation for compatibility with the integer-based compute engine 126. The multiformat controller 132 executes the above by ensuring that, irrespective of the underlying FP compute operation, the underlying compute components (e.g., MUX, adder, shifter, multiplier, etc.) performs the same operations as that is supported by the compute components (e.g., operations in which the compute components are specialized).

The multiformat controller 132 then controls the integer-based compute engines 126 to execute FP operations 112 (e.g., with the different portions serving as inputs to the FP operations) to generate different outputs. For example, the multiformat controller 132 may control the integer-based compute engines 126 based on the operational map 140 by executing commands to conform to the operational map 140. The different outputs are then combined together (e.g., via an accumulator within the integer based compute engines 126) to generate a final output for the FP operations. The final output is the FP outputs 134. The multiformat controller 132 may also control the integer-based compute engine 126 to generate the integer output 130, 128 based on the integer-based commands.

The multiformat controller 132 operates efficiently and with less hardware than the conventional processes. For example, a first conventional process may be unable to support multiple precisions. A second conventional process may include separate pipelines for each supported precision, which significantly increases cost, area, energy and idling of unused pipelines. Furthermore, the multiformat controller 132 may control and handle two sets of input data (two or more operations) in parallel and similarly to as described above such that two FP-based operations are executed in parallel on the integer-based compute engines 126, to ensure that the throughput achieved for an integer-based computation can be achieved for FP computation as well.

Thus, embodiments include hardware enhancements to the multiformat controller 132 which is highly configurable as well as having reduced area and reduced power. Embodiments are configurable to be compatible across various precisions (varying INT and/or FP formats), and also across various DNN functional operations (during both training and inference) like convolution, max pooling, activation function etc. The multiformat controller 132 may execute with standard compute blocks (e.g., multipliers and/or adders) to enhance the interoperability of the multiformat controller 132. For example, the multiformat controller 132 may be operated with any generic accelerator. As a more detailed example, the multiformat controller 132 (which may not include multipliers and adders) may be plugged into any generic compute engine (e.g., a graphics processing unit) or any other compute accelerator, without changing the core compute blocks (e.g., processing engine comprising or consisting of multipliers and adders) of the accelerator. Thus, embodiments may utilize a generic compute engine and/or accelerator to support a wide range of DNN workloads. The various configurability options available with the multiformat controller 132 helps to reduce the area and/or power of generic compute engines while supporting wide range of DNN workloads with high compute utilization.

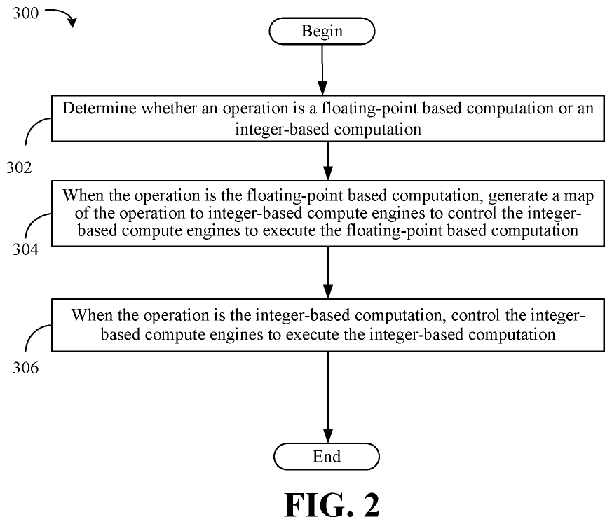

FIG. 2 shows a method 300 of controlling compute engines to execute FP operations according to embodiments herein. The method 300 may generally be implemented with the embodiments described herein, for example, the enhanced, multiformat control process 120 (FIG. 1), already discussed. More particularly, the method 300 may be implemented in one or more modules as a set of logic instructions stored in a machine-or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic include suitably configured programmable logic arrays (PLAs), field programmable gate arrays (FPGAs), complex programmable logic devices (CPLDs), and general purpose microprocessors. Examples of fixed-functionality logic include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out operations shown in the method 300 may be written in any combination of one or more programming languages, including an object-oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 302 determines whether an operation is a floating-point based computation or an integer-based computation. When the operation is the floating-point based computation, illustrated processing block 304 generates a map of the operation to integer-based compute engines to control the integer-based compute engines to execute the floating-point based computation. When the operation is the integer-based computation, illustrated processing block 306 controls the integer-based compute engines to execute the integer-based computation. The generating the map comprises dividing a floating-point number associated with the floating-point based computation into a plurality of portions, and assigning each of the plurality of portions to a different integer-based compute engine of the integer-based compute engines. The plurality of portions includes a sign portion, an exponent portion and a mantissa portion, and storing the sign portion into a sign register, the exponent portion into an exponent register and the mantissa portion into a mantissa register.

In some embodiments, the method 300 includes identifying weight data associated with the operation, where the weight data has a first number of dimensions, adjusting the weight data to increase the first number of dimensions to a second number of dimensions, storing the weight data having the second number of dimensions in a tile-based fashion to a memory, and storing input features associated with the operation and output features associated with the operation to the memory in the tile-based fashion. The operation is associated with a deep neural network workload. The integer-based compute engines execute one or more of partial reduction operations, quantization shifter operations, activation function operations or max pooling operations. The map further includes a finite state machine, and the method 300 further comprises controlling a flow of data to the integer-based compute engines based on the finite state machine, wherein the data is associated with the operation.

In some embodiments, the operation is the floating-point based computation and is associated with first and second floating-point numbers. The map includes one or more of an assignment of sign elements of the first and second floating-point numbers to an XOR gate of the integer-based compute engines, an assignment of exponent elements of the first and second floating-point numbers to an adder of the integer-based compute engines, and an assignment of mantissa elements of the first and second floating-point numbers to a multiplier of the integer-based compute engines.

Thus, the method 300 may reduce an amount of hardware required to execute integer and FP based operations since FP operations may execute on an integer-based compute engines and do not require specialized FP-based compute engines. Moreover, the method 300 further enhances efficiency by utilizing a significant portion of the integer-based compute engines during operation.

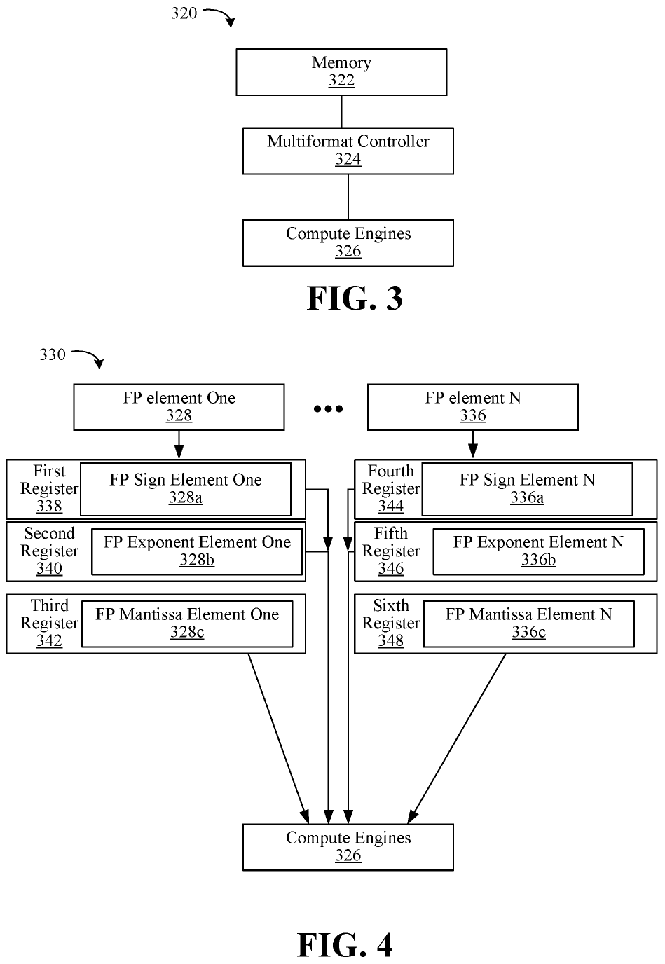

FIG. 3 illustrates a multiformat architecture 320 for executing DNN operations. The multiformat architecture 324 may generally be implemented with the embodiments described herein, for example, the enhanced, multiformat control process 120 (FIG. 1) and/or method 300 (FIG. 2), already discussed. As illustrated, a memory 322 is connected with the multiformat controller 324. The multiformat controller 324 is also connected to the compute engines 326. The multiformat controller 324 may retrieve FP data of a first precision from the memory 322, decompose the FP data into several components and control the compute engines 326 to execute operations based on the portions. The compute engines 326 may include processing units that are configured to execute in a second precision and/or integer data format. The second precision is different from the first precision.

FIG. 4 illustrates a decomposition and segregation process 330 of FP elements. The decomposition and segregation process 330 may be executed with a multiformat controller that identifies different types of data and divides the data into portions that are compatible with an underlying hardware architecture. For example, the process 330 may be executed with the multiformat controller 132 (FIG. 1) and/or the multiformat controller 324 (FIG. 3). The process 330 may also operate in conjunction with method 300 (FIG. 2).

A plurality of FP elements (e.g., numbers) associated with a FP computation includes FP element one 328-FP element N 336. The process 330 decomposes and/or divides each of the FP elements into constituent components. For example FP element one 328 is decomposed into FP sign element one 328 a, FP exponent element one 338b and FP mantissa element one 338c. Notably, each of the FP sign element one 338a, FP exponent element one 338b and FP mantissa element one 338c occupy different bit positions of the FP element one 338 and form a different part of the FP element one 338. The FP sign element one 338a, FP exponent element one 338b and FP mantissa element one 338c is stored in a first register 338 (e.g., sign register which is hardware), second register 340 (e.g., exponent register which is hardware) and third register 342 (e.g., mantissa register which is hardware) respectively. Thus, the FP sign element one 338a, FP exponent element one 338b and FP mantissa element one 338c are segregated into different ones of the first register 338, the second register 340 and the third register 342 to facilitate dispatch of input operands to different elements of the compute engines 326 (e.g., integer-based compute engines). Similarly, the FP element N 336 is decomposed into the FP sign element N 336a, FP exponent element N 336b and FP mantissa element N 336c, and stored in fourth, fifth and sixth registers 344, 346, 348 respectively.

The process 330 may further assign each of the FP sign element one 338a, FP exponent element one 338b, FP mantissa element one 338c, FP sign element N 336a, FP exponent element N 336b and FP mantissa element N 336c (e.g., a plurality of portions) to a different integer-based compute engine of the compute engines 326. During processing, the underlying hardware architecture of the compute engines 326 will process each of the FP sign element one 338a, FP exponent element one 338b, FP mantissa element one 338c, FP sign element N 336a, FP exponent element N 336b and FP mantissa element N 336c as integers. That is, the underlying hardware architecture will identify and treat each of the FP sign element one 338a, FP exponent element one 338b, FP mantissa element one 338c, FP sign element N 336a, FP exponent element N 336b and FP mantissa element N 336c as integers rather than FP numbers. For example, if a multiplication is to be executed with FP element one 338 and FP element N, the FP sign element one 338a and the FP sign element N would be provided to a multiplication element (e.g., an XOR gate which is integer-based) of the compute engines 326 to execute the multiplication operation. The FP exponent element one 338b and FP exponent element N 336b are provided to an integer-based adder of the compute engines 326 to execute an exponent addition operation. The FP mantissa element N 336c and the FP mantissa element one 338c are provided to an integer-based multiplier of the compute engines 326 to execute a multiplication operation.

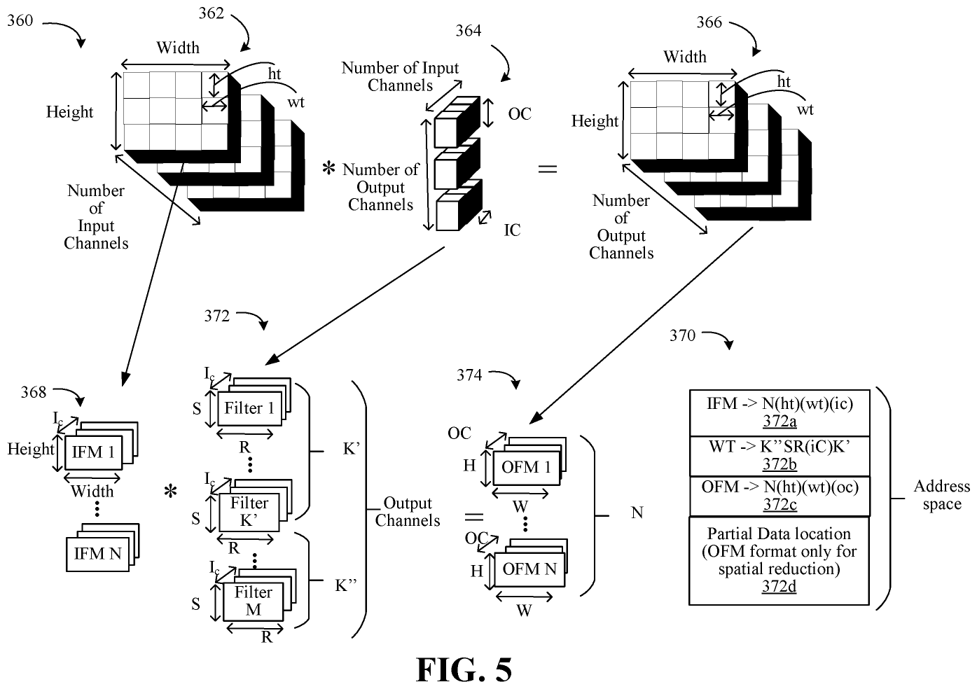

FIG. 5 illustrates a mapping process 360 to store input data, weights and output data. Input-Features 362 (IFMs mapped as Operand A), Weight-data 364 (WT mapped as an Operand B) and Output-Features 366 (OFMs mapped as an output operand) are provided. In order to effectively store the IFMs 362, WT 364 and OFMs 366 in memory, the IFMs 362, WT 364 and OFMs 366 may be divided into tiles. The mapping process 360 may generally be implemented with the embodiments described herein, for example, the enhanced, multiformat control process 120 (FIG. 1), method 300 (FIG. 2), multiformat architecture 324 (FIG. 3) and/or decomposition and segregation process 330 (FIG. 4), already discussed

For example, in a case of spatial partial reduction two sets of Partial Data are stored separately in memory: one partial data at the location of the OFM 366 and other partial data at the partial data location 372d as shown in FIG. 5. In the case of temporal partial reduction, one set of partial data is stored at the location of the OFM 366 which is then loaded into the hardware before calculating each row of OFM data. An LCE (e.g., multiformat controller and compute engines) assumes uninterrupted access with fixed cycle latency to memory array and may not support back-pressure or delay in read-return data.

The case of spatial partial reduction is described further. Spatial partial reduction occurs when two different sets of partial OFMs 366 are to be added to produce a final OFM 366. This is applicable when the size of a respective IFM of the IFMS 362 and WT, which will be used to generate the OFMs 366, is large such that the size of the memory cannot hold the entire respective IFM and WT. In such cases, embodiments divide the respective IFM and WT space, hence the memory can accommodate a set of the respective IFM and WT which will produce a partial OFM of the OFMS 362. After completing the entire respective IFM and WT space, all the partial OFMs are added to generate final an output OFM of the OFMS 366, which is done by spatial partial reduction.

Temporal partial reduction is now described. Temporal partial reduction is similar to spatial partial reduction, but instead of computing all partial OFMs of the OFMS 366 before performing addition (i.e., to merge the partial OFMs), embodiments compute one partial OFM, and then on the fly, add the one partial OFM with a previous partial OFM (i.e., compute and merge on the fly). Hence by the end of last set of a respective IFM of the IFMS 362 and WT, embodiments will obtain a final OFM of the OFMs 362. The above is applicable where a data needs to be added like an offset to OFM, or bias to the OFM, etc.

In order for compute engines to execute in an efficient manner and comply with memory requirements associated with the compute engines, the IFMs 362, the WT 364 and the OFMs 366 will be stored in manner that the compute engines expect and in a specific layout. Such examples of the layouts are shown in FIG. 5. A single IFM 362 includes 3 dimensions: height ht, width wt and input channels. Generally, a workload will have more than one IFM 362. Due to memory limitations, the entire IFM 362 is broken down into multiple tiles 368 and loaded into a memory subarray 370 (SA). The storage pattern of IFM 362 is N(ht)(wt)(ic) where is corresponds to input channel. For example, all channels related to an IFM tile element, including channels of the WT 364 and the OFMs 366, will be stored in order of execution, followed by next set of elements in the “ht” and “wt” directions. Once all elements within that IFM tile are completed, a next IFM tile will be picked in the same manner.

Notably, a dimensionality of the WT 364 may be increased. For example, the WT 364 may have four dimensions, the number of input channels, number of output channels, height of an output channel (OC) and length of an input channel (IC). The output channel dimension may be divided into two dimensions: K′ and K″ as shown in OFM tiles 374 to generate five dimensions.

After processing the data for a tile of IFM 362 and WT 364, associated hardware of the compute engines writes back the output data or OFMs 366 at a location reserved for OFMs 366 in (N(ht)(wt)(oc)) format. In a more detailed example, the IFMs 362 are split into several input tiles 368. For example, IFM 1 may correspond to a first portion of a first cube, while another tile (e.g., IFM 2) may correspond to a second portion of the first cube. In a more detailed example, the memory sub array 370 may store the input tiles 368 in first memory portion 372a, the weight tiles 372 in first memory portion 372b and the output tiles 374 into third memory portion 372c. The partial data location 372d stores partial data related to spatial reduction. In some examples, a multi-format controller assumes uninterrupted access with a fixed cycle latency a memory array.

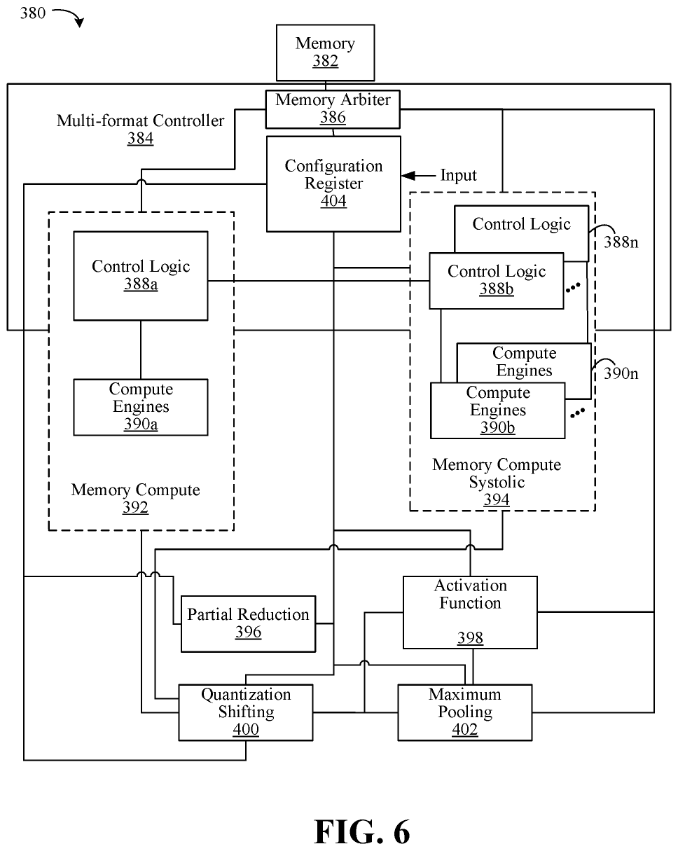

FIG. 6 illustrates a multiformat processing architecture 380 (e.g., an LCE with memory). The multiformat processing architecture 380 may generally be implemented with the embodiments described herein, for example, the enhanced, multiformat control process 120 (FIG. 1), method 300 (FIG. 2), multiformat architecture 324 (FIG. 3), decomposition and segregation process 330 (FIG. 4) and/or mapping process 360 (FIG. 5), already discussed. A multiformat controller 384 includes memory arbiter 386, configuration register 404 and control logic 388a-388n. The memory arbiter 386 is connected to a memory 382 to retrieve data from the memory 382. The configuration register 404 receives an input. The input may indicate data that is to be retrieved from the memory 382. The memory arbiter 386 may access the configuration register 404 to identify the data, and then retrieve the data from the memory 382. The memory arbiter 386 may provide the data to memory compute 392 and memory compute systolic 394. The memory compute 392 and memory compute systolic 394 include compute engines 390a-390n and a portion, control logic 388a-388n, of the multiformat controller 384. The compute engines 390a-390n may be any type of compute block (e.g., electronic circuitry, adder, multiplier, XOR gates, OR gates, AND gates, NOR gates, etc.).

Convolution and General Matrix Multiplication (GEMM) are two computations that neural networks herein may employ. Compute engines 390a-390n are designed with the capability of performing the Convolution and GEMM operations efficiently. IFMs may be with filters (e.g., weights) to generate OFMs. The IFMs and filters are input matrices. Each element in an input matrix (IFM) is represented as an integer or a FP datatype, where the exact precision (e.g., 8, 16, 32, etc.) is configured an application by application basis.

As noted herein, embodiments develop an efficient control path which caters to both integer and FP datatypes with multiple precisions. Doing so involves data preprocessing and setup for various datatypes and precisions. The data preprocessing and setup may include manipulating and organizing the input IFM and filter data.

The multiformat processing architecture 380 may include five compute pipelines that execute different functions, including: 1) partial reduction 396, specifically convolution and temporal reduction, 2) partial reduction 396, specifically spatial partial reduction with the partial reduction 396, 3) quantization shifting 400, 4) activation functions 398 and 5) max pooling 402. The compute engines 3901-390n may implement the five compute pipelines.

Each pipeline stage may be controlled by a bit in a command (e.g., LCE_OPCODE[4:0]) which may be issued by the multiformat controller 384. The pipe stages support integer/fp operations which is again controlled by a command (e.g., LCE_OPCODE[5]) from the multiformat controller 384. All possible combinations between these five pipelines may not be permitted in some embodiments (e.g., only valid opcodes are allowed). All operations are handled by the multiformat controller 384 that provides different pipelines (e.g., including simple adder and/or multiplier blocks) with the appropriate data, and also extract required functionality from the different pipelines.

Below Table I illustrates various input data pointers for the multiformat processing architecture 380 to function with 128 bit wordline per memory transaction. The data pointers may be provided through the configuration register 404 (as input data) from another controller. These values are written to the configuration register 404 in three phases using a wdata bus with lce_en signal indicating how wdata will to be processed. Wdata is memory write data. Embodiments send the configuration data on to the write data bus. Due to this, overloading of the write data bus (e.g., a memory associated write data bus) with configuration data, embodiments save extra wires that may otherwise be needed for programing the control logic.

TABLE I

| | | | Read | | | | Value |
|---|---|---|---|---|---|---|---|
| | | | Write | | | | on |
| | | | (RW) | | | | power |
| Register group | Offset | Register Name | type | Bits | Description | | up |
| LCE_CFG_PHASE_1 | 0x00000000 | IFM_HEIGHT_H | RW | 127:112 | ifm_row_size | | 0 |
| | | IFM_WIDTH_W | RW | 111:96 | ifm_column_size | | 0 |
| | | Reserved | RW | 95:72 | Reserved | | 0 |
| | | Reserved | RW | 71:69 | Reserved | | 0 |
| | | LCE_REDUCTION | RW | 68 | Reduce working LCE count to 2 from 4, | | 0 (only |
| | | | | | LCE_REDUCTION = 1 −> 2 LCE mode | | with 4 |
| | | | | | LCE_REDUCTION = 0 −> 4 LCE mode | | LCE design |
| | | | | | | | else |
| | | | | | | | reserved) |
| | | LCE_CONFIG_REG_PHASE | RW | 67:66 | Config reg phase value (Should | | 0 |
| | | | | | be same as “Register index”) | | |
| | | Reserved | RW | 65:21 | Reserved | | 0 |
| | | QUANT_BASE_ADDR | RW | 20:8 | Base address for channel wise | | 0 |
| | | | | | quantization shift value. | | |
| | | LCE_OPCODE | RW | 7:0 | (this field should be same as | | 0 |
| | | | | | 0x0000_0001[7:0]) | | |
| | | | | | Opcode[7:0] | | |
| | | | | | [7] - compute_enable | | |
| | | | | | [6] - RESERVED | | |
| | | | | | [5] - Int/FP | | |
| | | | | | [4] - Conv/GEMM | | |
| | | | | | [3] - Quantization | | |
| | | | | | [2] - activation | | |
| | | | | | [1] - Poolling | | |
| | | | | | [0] - Partial reduction | | |
| LCE_CFG_PHASE_2 | 0x00000001 | LCE_COMPUTE_PRECISION | RW | 127:126 | compute_mode | | 0 |
| | | | | | LCE_OPCODE[5] = 1 (FP)/0(INT) | | |
| | | | | | Encode | INT | |
| | | | | | 00 | 4 | |
| | | | | | 01 | 8 | |
| | | | | | 10 | 16 | |
| | | | | | 11 | RES | |
| | | | | | *FP16 (sign = 1, exp = 5, mantissa = 8) | | |
| | | CONV_FILTER_SIZE | RW | 125:124 | filter_type | | 0 |
| | | | | | Encoding | | |
| | | | | | 00 | | |
| | | | | | 01 | | |
| | | | | | 10 | | |
| | | | | | 11 | | |
| | | RESERVED | RW | 123:120 | Reserved bits. | | 0 |
| | | IFM_EDGE_PAD_ENABLE | RW | 119:116 | zero_padding_config | | 0 |
| | | | | | one bit per edge | | |
| | | | | | Bit_num | | |
| | | | | | 0 | | |
| | | | | | 1 | | |
| | | | | | 2 | | |
| | | | | | 3 | | |
| | | | | | All combinations of this | | |
| | | | | | 4-bit number is supported | | |
| | | IFM_WT_ELEMENT_SIGN | RW | 115:114 | signed operand indicates that | | 0 |
| | | | | | element if signed or unsigned | | |
| | | | | | bit_value = 0(UINT)/1(SINT) | | |
| | | | | | Bit_num | | |
| | | | | | 0 | | |
| | | | | | 1 | | |
| | | CONV_HORIZONTAL_STRIDE | RW | 113:113 | horizontal stride | | 0 |
| | | | | | stride = 0(one)/1(two) | | |
| | | CONV_VERTICAL_STRIDE | RW | 112:112 | vertical stride | | 0 |
| | | | | | stride = 0(one)/1(two) | | |
| | | NUM_OFM_CHANNELS | RW | 111:96 | num_of_filters (K) | | 0 |
| | | | | | (K = K′ * K″) | | |
| | | PARTIAL_BASE_ADDR | RW | 95:83 | Base address for spatial and | | 0 |
| | | | | | temporal reduction. Space | | |
| | | | | | allocated based on increased/ | | |
| | | | | | partial accumulation width | | |
| | | OFM_BASE_ADDR | RW | 82:70 | OFM base address | | 0 |
| | | Reserved | RW | 69:68 | Reserved | | 0 |
| | | LCE_CONFIG_REG_PHASE | RW | 67:66 | Config reg phase value (Should | | 0 |
| | | | | | be same as “Register index”) | | |
| | | NUM_IFM | RW | 65:50 | number of input features maps | | 0 |
| | | NUM_IFM_CHANNEL | RW | 49:34 | =(C) as per mapping diagram | | 0 |
| | | IFM_BASE_ADDR | RW | 33:21 | operand_a_base_address for | | 0 |
| | | | | | GEMM base address of matrix-A | | |
| | | WT_BASE_ADDR | RW | 20:8 | operand_b_base_address for | | 0 |
| | | | | | GEMM base address of matrix-B | | |
| | | LCE_OPCODE | RW | 7:0 | (this field should be same as | | 0 |
| | | | | | 0x0000_0000 [7:0]) | | |
| | | | | | Opcode[7:0] | | |
| | | | | | [7] - compute_enable | | |
| | | | | | [6] - RESERVED | | |
| | | | | | [5] - Int/FP | | |
| | | | | | [4] - Conv/GEMM | | |
| | | | | | [3] - Quantization | | |
| | | | | | [2] - activation | | |
| | | | | | [1] - Poolling | | |
| | | | | | [0] - Partial reduction | | |
| LCE_CFG_PHASE_3 | 0x00000002 | Reserved | RW | 127:68 | | | 0 |

| LCE_CONFIG_REG_PHASE | RW | 67:66 | Config reg phase value (Should | 0 |
|---|---|---|---|---|
| | | | be same as “Register index”) | |
| Reserved | RW | 65:58 | | 0 |

| | | | | |
|---|---|---|---|---|
| SIGNED_OPS_ACT | RW | 56:56 | Element polarity while performing | 0 |
| | | | standalone activation function | |
| | | | 0 → unsigned | |
| | | | 1 → signed | |
| | | | [this field is overwritten by the | |
| | | | IFM_WT_ELEMENT_SIGN | |
| | | | while performing activation | |
| | | | followed by CONV/GEMM] | |
| SIGNED_OPS_POOL | RW | 57:57 | Element polarity while performing | 0 |
| | | | standalone pooling function | |
| | | | 0 → unsigned | |
| | | | 1 → signed | |
| | | | [this field is overwritten by the | |
| | | | IFM_WT_ELEMENT_SIGN | |
| | | | while performing pooling | |
| | | | followed by CONV/GEMM] | |
| NUM_ENTRIES_POOL | RW | 55:44 | Number of memory word lines for | 0 |
| | | | pooling function. | |
| | | | (quantization operation happens | |
| | | | per element basis) | |
| | | | Expected input element value is | |
| | | | quantized | |
| NUM_ENTRIES_ACT | RW | 43:32 | Number of memory word lines for | 0 |
| | | | activation function. | |
| | | | (quantization operation happens | |
| | | | per element basis) | |
| | | | Expected input element value is | |
| | | | quantized | |
| NUM_ENTRIES_QUANT | RW | 31:20 | Number of memory word lines to | 0 |
| | | | be quantized. | |
| | | | (quantization operation happens | |
| | | | per element basis) | |
| | | | Expected input element value is | |
| | | | quantized | |
| NUM_ENTRIES_PARTIAL | RW | 19:8 | Number of memory word lines for | 0 |
| | | | partial reduction function. | |
| | | | (partial reductionoperation | |
| | | | happens per element basis) | |
| | | | Expected input element value is | |
| | | | quantized | |
| LCE_OPCODE | RW | 7:0 | (this field should be same as | 0 |
| | | | 0x0000_0000 [7:0]) | |
| | | | Opcode[7:0] | |
| | | | [7] - compute_enable | |
| | | | [6] - RESERVED | |
| | | | [5] - Int/FP | |
| | | | [4] - Conv/GEMM | |
| | | | [3] - Quantization | |
| | | | [2] - activation | |
| | | | [1] - Poolling | |
| | | | [0] - Partial reduction | |

Table II below shows the opcodes for the multiformat processing architecture 380. Some combinations of opcodes may be avoided for validity constraints. Convolution/General matrix multiply (Gemm) engines and spartial partial reduction may not be programmed together. If Conv/Gemm and partial reduction bits are enabled it may trigger temporal partial reduction which is part of convolution engine itself. Operations like activation and pooling may be executed after a convolution operation is completed and a final output is quantized (e.g., activation and pooling may operate on the quantized input only). The input to partial reduction and quantization blocks may be increased with increased precison (e.g., 16 bit for 4 bit operation and 32 bit for 16 bit operations). If a 2-LCE/4-LCE systolic connection design is implemented, some embodiments may set input features in multiples of 2/4 respectively.

TABLE II
LCE_OPCODE

| Int/ | Conv/ | | | | Partial | |
|---|---|---|---|---|---|---|
| FP | GEMM | Quantization | activation | Pooling | reduction | Functionality |
| 0 | 1 | 0 | 0 | 0 | 0 | Conv/GEMM (Int) |
| 0 | 1 | 1 | 0 | 0 | 0 | Conv/GEMM + Quantization (int) |
| 0 | 1 | 1 | 0 | 1 | 0 | Conv/GEMM + Quantization + Pooling (int) |
| 0 | 1 | 1 | 1 | 0 | 0 | Conv/GEMM + Quantization + Activation (int) |
| 0 | 1 | 1 | 1 | 1 | 0 | Conv/GEMM + Quantization + Activation + Pooling (int) |
| 0 | 0 | 1 | 0 | 0 | 0 | Quantization (Int) |
| 0 | 0 | 1 | 0 | 1 | 0 | Quantization + Pooling (int) |
| 0 | 0 | 1 | 1 | 0 | 0 | Quantization + Activation (int) |
| 0 | 0 | 1 | 1 | 1 | 0 | Quantization + Activation + Pooling (int) |
| 0 | 0 | 0 | 1 | 0 | 0 | Activation (Int) |
| 0 | 0 | 0 | 1 | 1 | 0 | Activation + Pooling (Int) |
| 0 | 0 | 0 | 0 | 1 | 0 | Pooling (Int) |
| 0 | 0 | 0 | 0 | 0 | 1 | Partial Reduction (Int) |
| 0 | 0 | 1 | 0 | 0 | 1 | Partial Reduction + Quantization (int) |
| 0 | 0 | 1 | 0 | 1 | 1 | Partial Reduction + Quantization + Pooling (int) |
| 0 | 0 | 1 | 1 | 0 | 1 | Partial Reduction + Quantization + Activation (int) |
| 0 | 0 | 1 | 1 | 1 | 1 | Partial Reduction + Quantization + Activation + Pooling (int) |
| 0 | 1 | 0 | 0 | 0 | 1 | Conv/GEMM + Partial Reduction (Int) (temporal reduction) |
| 0 | 1 | 1 | 0 | 0 | 1 | Conv/GEMM + Partial Reduction + Quantization (int) (temporal reduction) |
| 0 | 1 | 1 | 0 | 1 | 1 | Conv/GEMM + Partial Reduction + Quantization + Pooling (int) (temporal reduction) |
| 0 | 1 | 1 | 1 | 0 | 1 | Conv/GEMM + Partial Reduction + Quantization + Activation (int) (temporal reduction) |
| 0 | 1 | 1 | 1 | 1 | 1 | Conv/GEMM + Partial Reduction + Quantization + Activation + Pooling (int) |
| | | | | | | (temporal reduction) |
| 1 | 1 | 0 | 0 | 0 | 0 | Conv/GEMM (FP) |
| 1 | 1 | 1 | 0 | 0 | 0 | Conv/GEMM + Quantization (FP) |
| 1 | 1 | 1 | 0 | 1 | 0 | Conv/GEMM + Quantization + Pooling (FP) |
| 1 | 1 | 1 | 1 | 0 | 0 | Conv/GEMM + Quantization + Activation (FP) |
| 1 | 1 | 1 | 1 | 1 | 0 | Conv/GEMM + Quantization + Activation + Pooling (FP) |
| 1 | 0 | 1 | 0 | 0 | 0 | Quantization (FP) |
| 1 | 0 | 1 | 0 | 1 | 0 | Quantization + Pooling (FP) |
| 1 | 0 | 1 | 1 | 0 | 0 | Quantization + Activation (FP) |
| 1 | 0 | 1 | 1 | 1 | 0 | Quantization + Activation + Pooling (FP) |
| 1 | 0 | 0 | 1 | 0 | 0 | Activation (FP) |
| 1 | 0 | 0 | 1 | 1 | 0 | Activation + Pooling (FP) |
| 1 | 0 | 0 | 0 | 1 | 0 | Pooling (FP) |
| 1 | 0 | 0 | 0 | 0 | 1 | Partial Reduction (FP) |
| 1 | 0 | 1 | 0 | 0 | 1 | Partial Reduction + Quantization (FP) |
| 1 | 0 | 1 | 0 | 1 | 1 | Partial Reduction + Quantization + Pooling (FP) |
| 1 | 0 | 1 | 1 | 0 | 1 | Partial Reduction + Quantization + Activation (FP) |
| 1 | 0 | 1 | 1 | 1 | 1 | Partial Reduction + Quantization + Activation + Pooling (FP) |
| 1 | 1 | 0 | 0 | 0 | 1 | Conv/GEMM + Partial Reduction (FP) (temporal reduction) |
| 1 | 1 | 1 | 0 | 0 | 1 | Conv/GEMM + Partial Reduction + Quantization (FP) (temporal reduction) |
| 1 | 1 | 1 | 0 | 1 | 1 | Conv/GEMM + Partial Reduction + Quantization + Pooling (FP) (temporal reduction) |
| 1 | 1 | 1 | 1 | 0 | 1 | Conv/GEMM + Partial Reduction + Quantization + Activation (FP) (temporal reduction) |
| 1 | 1 | 1 | 1 | 1 | 1 | Conv/GEMM + Partial Reduction + Quantization + Activation + Pooling (FP) |
| | | | | | | (temporal reduction) |

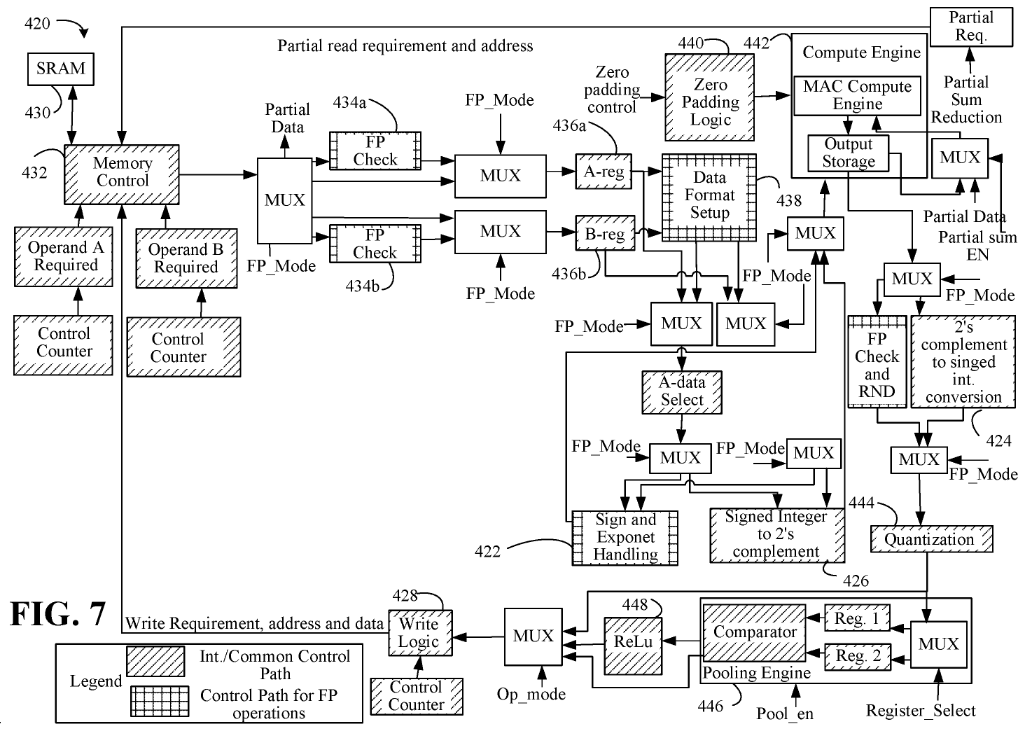

FIG. 7 is a DNN architecture 420 that is represented as a detailed block diagram. The DNN architecture 420 may generally be implemented with the embodiments described herein, for example, the enhanced, multiformat control process 120 (FIG. 1), method 300 (FIG. 2), multiformat architecture 324 (FIG. 3), decomposition and segregation process 330 (FIG. 4), mapping process 360 (FIG. 5) and/or the multiformat processing architecture 380 (FIG. 6), already discussed. The integer/common control path is represented as diagonal lines while the control path for FP operation is represented with the grid lines. The DNN architecture 420 represents how various blocks are arranged such that DNN operations are handled using a same control engine. The compute engine 442 shows a generic compute engine comprising standard multiply and accumulate blocks. For FP operations, sign and exponent operations are handled outside the compute engine 442 in the sign and exponent handling 422. Operand reads are controlled using control blocks (e.g., finite state machine). The memory control 432 retrieves an operand from static random access memory (SRAM) 430. Once data of the operand is read, the FP checks 434a detect whether the data has an exception case. For example, an exception case may include the data being infinite, zero, not a number, etc. The A-register 436a and B-register 436b may be set to indicate whether the data includes the exception case. The data format setup 438 separates the sign portion, the mantissa portion and the exponent portion of the floating point number into different numbers that may be stored in different registers. Data format setup 438 is a step specific to FP operation where sign, exponent and mantissa bits are separated out to handle them appropriately inside control and compute blocks. 2's complement blocks 424, 426 convert negative numbers into 2's complement positive numbers and vice versa at appropriate stages (e.g., only in case of integer operations). Write logic 428 includes a control counter to keep track of how processed OFMs are written at correct position in the memory. Zero padding logic 440 applies zero padding to the data to execute some operations, such as convolution.

The compute engine 442 may include a multiplier, adder and a shifter. The compute engine 442 may be a general MAC-based compute engine. The outputs of the compute engine 442 may be stored in output storage (e.g., registers). The quantization 444 quantizes numbers, and may be executed on the compute engine 442. The pooling engine 446 includes several components including a comparator. The rectified linear activation function 448 may execute in conjunction with the compute engine 442.

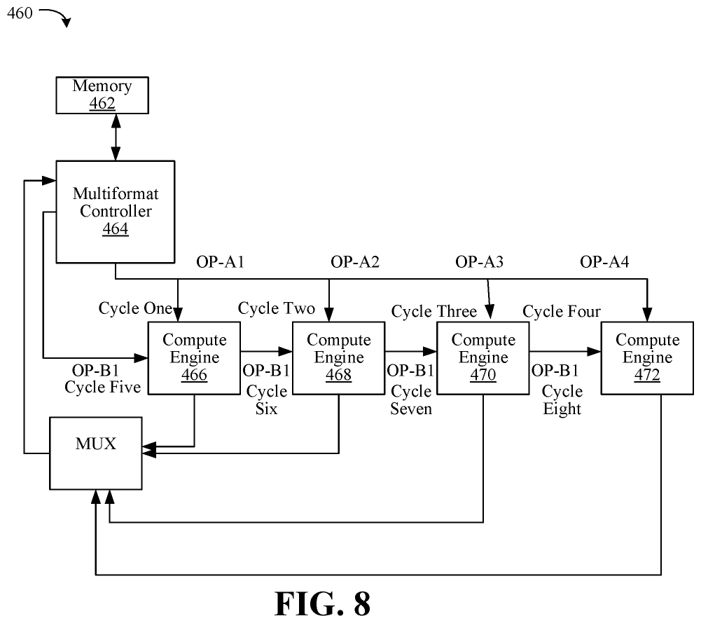

FIG. 8 represents a systolic multiformat processing architecture 460. The systolic multiformat processing architecture 460 may generally be implemented with the embodiments described herein, for example, the multiformat control process 120 (FIG. 1), method 300 (FIG. 2), multiformat architecture 324 (FIG. 3), decomposition and segregation process 330 (FIG. 4), mapping process 360 (FIG. 5), the multiformat processing architecture 380 (FIG. 6) and/or DNN architecture 420 (FIG. 7). The multiformat controller 464 is connected in a systolic manner to the compute engines 466, 468, 470, 472 to maximize the utilization of operand fetched from memory. The multiformat controller 464 further is connected to memory 462 to retrieve data. As illustrated in FIG. 8, the compute section comprising compute engines 466, 468, 470, 472, scales with respect to compute requirement. The same multiformat controller 464 may be used to feed all compute engines 466, 468, 470, 472. The systolic multiformat processing architecture 460 is an example of compute scaling with the same memory bandwidth in that the compute engines may increase in number, and operated by only one multiformat controller 464.

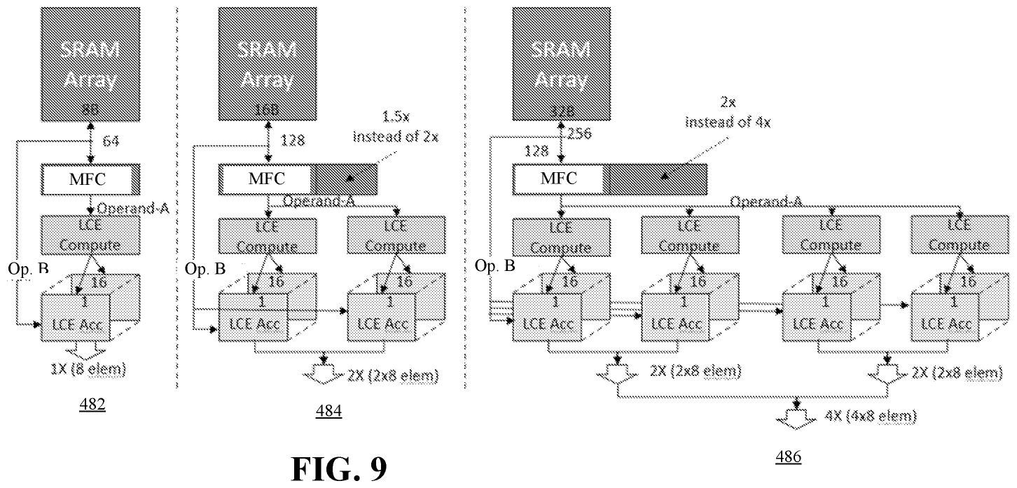

FIG. 9 illustrates scaling of multiformat controllers. The 8 Byte architecture 482, the 16 Byte architecture 484 and 32 Byte architecture 486 may generally be implemented with the embodiments described herein, for example, the multiformat control process 120 (FIG. 1), method 300 (FIG. 2), multiformat architecture 324 (FIG. 3), decomposition and segregation process 330 (FIG. 4), mapping process 360 (FIG. 5), the multiformat processing architecture 380 (FIG. 6), DNN architecture 420 (FIG. 7) and/or systolic multiformat processing architecture 460 (FIG. 8).

The multiformat controllers may be scaled with an increase in wordlength (BW) from memory. For example, the 8 Byte architecture 482 includes a multiformat controller that is a first size. The 16 Byte architecture 484 includes a multiformat controller that is 1.5 times the first size. The 32 Byte architecture 486 includes a multiformat controller that is 2 times the first size. Thus, the multiformat controllers expands in size as the word size increases, but the growth of the multiformat controllers is proportionally smaller as compared to the growth in compute (which grows linearly). Hence the multiformat controllers allows embodiments herein to support wide range of bandwidth options from memory.

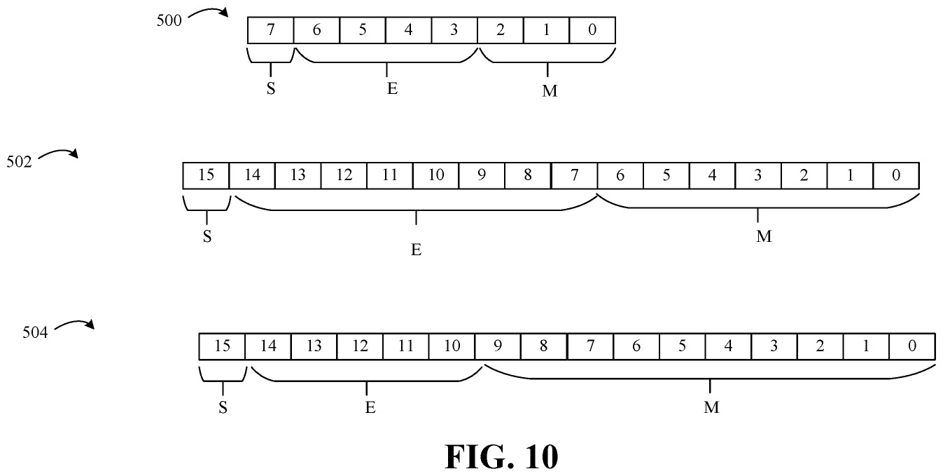

FIG. 10 illustrates different formats for FP numbers (e.g., input data). The FP number formats may generally be implemented with the embodiments described herein, for example, the multiformat control process 120 (FIG. 1), method 300 (FIG. 2), multiformat architecture 324 (FIG. 3), decomposition and segregation process 330 (FIG. 4), mapping process 360 (FIG. 5), the multiformat processing architecture 380 (FIG. 6), DNN architecture 420 (FIG. 7), systolic multiformat processing architecture 460 (FIG. 8) and/or multiformat controllers (FIG. 9). Some embodiments process the input data to a format required for the compute operations. For integer operations, the data preprocessing is minimal. For unsigned integer operations, the input data is directly passed on to the compute units. For signed integer operations, the signed number is converted to integer from two's compliment representation before providing to the compute engine. The control path may perform additional data preprocessing on FP numbers before providing to the compute unit.

A multiformat controller may support various different FP precisions, such as FP8 as illustrated in FP8 number 500, BF16 as illustrated in second number 502 and FP16 as illustrated in third number 504. A FP number representation has three components: Sign (S), Exponent (E) and Mantissa (M). Compute operations involve manipulating and performing computations on these three parts for FP operations. When an input IFM or filter data is received by the multiformat controller, the multiformat controller segregates the input data into sign(S), exponent(E) and mantissa(M) fields. As the multiformat controller is capable of supporting several different FP formats as shown in first number 500, second number 504 and third number 504, the splitting of the input data to sign, exponent and mantissa fields depend on the precision selected. The below table summarizes the three fields for various FP precisions.

TABLE III

| Floating-point | | | | |
|---|---|---|---|---|
| Format | Precision | Sign(S) | Exponent(E) | Mantissa(M) |
| FP8 | 8 bits | 1 | 4 | 3 |
| BF16 | 16 bits | 1 | 8 | 7 |
| FP16 | 16 bits | 1 | 5 | 10 |

For an FP8 number 500, data (referred to as A0), A0[0:2] represents the mantissa. To enable this mantissa to be able to be used by a 4-bit compute unit, the multiformat controller executes zero padding at the most-significant bit (MSB) to create a 4-bit mantissa. A0[7] is the sign bit of the input FP8 data. Table IV summarizes the format:

TABLE IV

| A0 format | S | E | M |
|---|---|---|---|
| FP8 | A0[7] | A0[6:3] | {1′b0, A0[2:0]} |

In Table IV, the “1′b0” notation is a zero padding at the most-significant bit (MSB) to create a 4-bit mantissa. In a hardware description language (e.g., Verilog), embodiments pad an extra bit as follows. “1′” indicates how many bits are to be inserted, “b” indicates that value to that bit is indicated in binary format and followed by the actual value of that bit. 1′b0: means that embodiments adding one bit whose value is 0 in binary.

For a 128-bit wide memory, storing IFM and filter data (i.e., weight data) with a precision of 8-bit, a single read operation would fetch 16, FP8 elements. If the same compute unit is reused for both integer and FP computations, the throughput achieved by processing a single FP8 element is half than that achieved by processing a single INT8 element. In detail, the FP8 number is segregated into exponent and mantissa fields, and at a single time either an exponent operation or a mantissa operation will be executed. The overall throughput achieved after performing computation of all 16, FP8 elements fetched from a memory location, is half than that of a similar integer operation performed on 16 INT8 elements fetched from one memory location. Hence to maintain the same overall throughput, which is achieved during an integer operation, a second set of IFM elements are fetched by the multiformat controller, from the subsequent memory location, preprocessed and passed to the compute unit. This ensures that the throughput achieved during an integer operation is achieved during a FP operation as well.

For example, suppose that an operation occurs with INT8 precision. The corresponding number is an 8 bit number. So with a memory of a 128 bit word, embodiments may accommodate 16 INT 8 values. Further assume that embodiments have a compute engine capable of handling all 16 INT8 values in a single cycle. When embodiments switch to BF16 (FP) format, the BF16 format consists of a 16 bit element, so in the same memory of 128 bit word, embodiments now will be able to store only 8 BF16 values. Since controllers as described herein map FP operations onto the INT compute (which is capable of 16 operations per cycle), 8 BF16 values will result into loss of throughput as only half of the compute engines have data to work with. Hence the controller fetches a second memory location (another 8 BF16 values), groups the first and second memory locations together to create a 16 BF16 elements and then schedule to the compute engines. This is how throughput for FP is increased to maintain with INT throughput.

The 4-bit mantissas of the 16 FP8 elements fetched from a first memory location are first segregated from the FP8 number and then concatenated together to form a 64-bit mantissa vector. Similarly, a 64-bit mantissa vector is created for a second data set fetched from a second memory location after the first memory location. These two vectors are further concatenated together to form a 128-bit vector and stored in a 128-bit mantissa register MR.

Similarly, 4-bit exponents of the 16 elements fetched from the first memory location are concatenated along with the 4-bit exponents of the 16 elements fetched from the second memory location to create a 128-bit exponent vector. This is stored in a 64-bit exponent register ER. Similarly, the sign bits are stored in separate sign registers.

The segregation of exponents and mantissas in this manner facilitates data dispatch to the compute by providing only the sign register for sign manipulations, exponent register for exponent manipulations and mantissa register for mantissa related manipulations. Doing so keeps the computations independent of performing any further data preprocessing for compute operations.

A similar approach of segregation of the number to sign, exponent and mantissa bits is done for the other supported FP formats as well. For the second number 502 (i.e., a BF16 FP number, also referred to as A0), A0[15] is the sign bit, A0[14:7] is the 8-bit exponent. The 8-bit exponents can be considered as two, 4-bit sub exponents E1 and E2 which can be fed to 4-bit compute unit. A0[6:0] represents the 7-bit mantissa of which A0[3:0] is the smaller 4-bit sub mantissa, M1. The upper 3 bits of the mantissa is zero padded to create a 4-bit sub mantissa, M2. Table V summarizes the above:

TABLE V

| A0 format | S | E1 | E2 | M1 | M2 |
|---|---|---|---|---|---|
| BF16 | A0[15] | A0[10:7] | A0[14:11] | A0[3:0] | {1′b0, A0[6:4]} |

In Table V, the notation “1′b0” means that zero padding at the most-significant bit (MSB) to create a 4-bit mantissa. In a hardware description language (e.g., Verilog), embodiments pad an extra bit as follows. A “1′” indicates how many bits we are inserting, “b” indicates that value to that bit is indicated in binary format and followed by the actual value of that bit. In “1′b0” embodiments add one bit whose value is 0 in binary.

For a 128-bit wide memory having BF16 numbers, a single read of one memory location fetches, eight BF16 elements. As in the case with FP8 format, to preserve the throughput as that obtained by an integer type operation with the same precision (INT16), two locations of the memory are read. The resultant mantissas and exponents are concatenated and stored in the 128-bit mantissa register MR and 128-bit exponent register ER respectively, if the number format selected is BF16.

For a FP number as shown in the third number 504 (which is referred to as A0 below) in FP16 format, A0[15] is the sign bit. Bits A0[13:10] is the lower sub exponent E1. Bit A0[14] is zero padded to create upper sub exponent E2. The 10 bits A0[9:0] is truncated to A0[9:2] as only 8-bit mantissas are supported. A0[5:2] is considered as the lower sub mantissa M1 and A0[9:6] is considered as the upper sub mantissa M2. Table VI summarizes the above:

TABLE VI

| A0 format | S | E1 | E2 | M1 | M2 |
|---|---|---|---|---|---|
| FP16 | A0[15] | A0[13:10] | {3′b0, A0[14]} | A0[5:2] | A0[9:6] |

In Table VI, the notation “3′b0” indicates zero padding at the three most-significant bit (MSB) to generate a 4-bit exponent. In In a hardware description language (e.g., Verilog), embodiments pad extra bits as follows. “3” indicates how many bits are to be inserted, “b” indicates that a value to that bit is indicated in binary format and followed by the actual value of that bit. For “3′b0” embodiments add three bits whose value is 0 in binary (e.g., E2={0,0,0,A[14]}).

As in the case with BF16, to preserve the throughput as that obtained by an integer type operation with the same precision (INT16), two locations of the memory are read. The resultant mantissas and exponents are concatenated and stored in the 128-bit mantissa register MR and 128-bit exponent register ER respectively, if the number format selected is FP16. This above segregation process and grouping of the exponent and mantissa bits may be executed for both IFM and filter inputs.

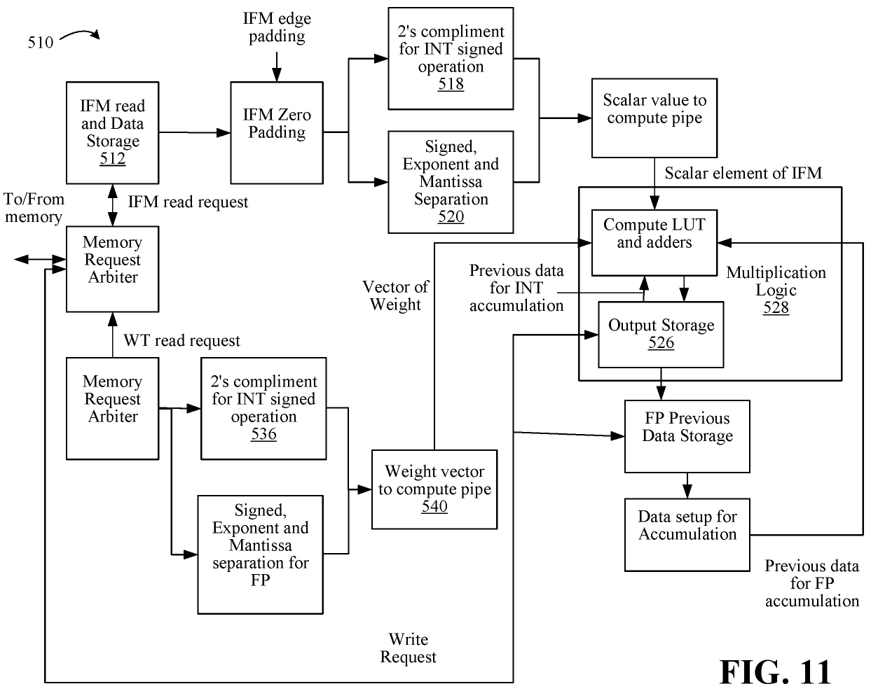

FIG. 11 shows an LCE 510 comprising a multiformat controller and compute engines that supports element-to-element multiplication as Scalar to Vector multiplication. Input features are (e.g., Matrix-A) stored locally, for example in the IFM read and data storage 512, and applied as Scalar elements. Weight data (Matrix-B) is streamed directly from memory-array to the compute block as vectors through the weight vector to compute pipe 540. Operands are fetched from the memory array base address as specified by a configuration register. Output data or the partially computed data is written back to a memory array, such as output storage 526, at specified memory locations. Output storage 526 initiates write operations if quantization, activation and max pooling block are not enabled.

For any FP computation, the sign of the computed output may be determined by an XOR operation of the sign bits of input operands. For instance, if the precision chosen is BF16, C[15]=A[15]\hat{ }B[15], where A and B are the input operands and C is the computed output. Since the sign bits of the input operands are segregated and stored in sign registers, the generation of the resultant sign bit for any other FP compute is a XOR between the contents.

The remaining portion of the FP compute involves exponent or mantissa manipulation. The multiformat controller may generates control signals exp—en, mant_en and acc_en indicating a required operation on exponent or mantissa. Performing multiplication of two FP numbers includes adding the exponents of the two operands to generate the resultant exponent. In the data preprocessing stage of the IFM and filter operands, the exponents are already segregated and stored in ER registers allocated for IFM and filters.

When an exp_en is asserted the contents from the IFM's and filter's ER registers are made available iteratively to an adder in the multiplication logic 528 to perform exponent addition. The resultant exponent once available from the multiplication logic 528 may be stored in the control unit, for further compute operations. In such a way, the LCE control executes the data preprocessing and necessary control logic generation so that the compute can be a standalone adder unit to perform exponent addition.

Once the exponent addition is completed, the resultant mantissa may be computed with the Signed, Exponent and Mantissa Separation 520. The resultant mantissa of multiplication of two FP numbers is derived by multiplying the mantissas of the input operands. The state machine in the LCE control generates mant en upon de-assertion of exp_en. The number of cycles the mant en needs to be enabled, for a 4-bit compute, depends on the data precision selected. For FP8, mant_en may be single cycle, whereas for BF16 and FP16, mant en needs to be 2 clock cycles as mantissas are arranged as two, 4-bit sub mantissas and fed to 4-bit compute unit. This may be executed by a dedicated counter in the control unit which asserts the mant en for sufficient number of cycles depending on the data precision selected.

The mantissas of the input operands are already segregated and stored in MR registers allocated for IFM and filters. When mant en is enabled, the contents from the MR registers are iteratively made available for components of a compute engine to perform the required multiplication. In such a fashion, the compute needed for performing mantissa multiplication are pure multiplier units of the multiplication logic 528. A normal multiplier used for INT operation is sufficient for the mantissa multiplication as all the necessary control is efficiently done by the LCE. The resultant mantissa once available from the multiplication logic 528 may be stored. The existence of this feedback path from compute engine to multifunction controller facilitates manipulation of previous computation result for future compute operations.

For a convolution operation, the results of the FP multiplications are required to be accumulated to produce the resultant FP number. The exponents of the two operands are compared to find the greater exponent. The resultant exponent is this greater exponent. To find the resultant mantissa, the difference between the exponents of the two operands are determined. The mantissa of the smaller exponent is then shifted right by the difference amount. This is then added with the mantissa of the greater exponent to produce the resultant mantissa.

The LCE 510 is designed to determine the greater exponent by comparing the exponent of the current compute multiplication output and the exponent of the previous resultant stored in register. To compute the mantissa, the LCE 510 calculates the difference amount of the exponents to determine the shift amount. The difference is calculated between the exponent of the current compute multiplication output available from a compute unit such as the multiplication logic 528, and the exponent of the previous resultant fed back from the compute engine and stored in resultant register. This difference amount along with the mantissas of both operands are then made available during acc en phase. Acc_en is generated by an internal FSM of the multiformat controller once mant en is deasserted. The multiformat controller also provides information on the mantissa that needs to be shifted by the shift amount. The LCE 510 may shift the required mantissa by the shift amount and then add the mantissa with the mantissa of the other operand.

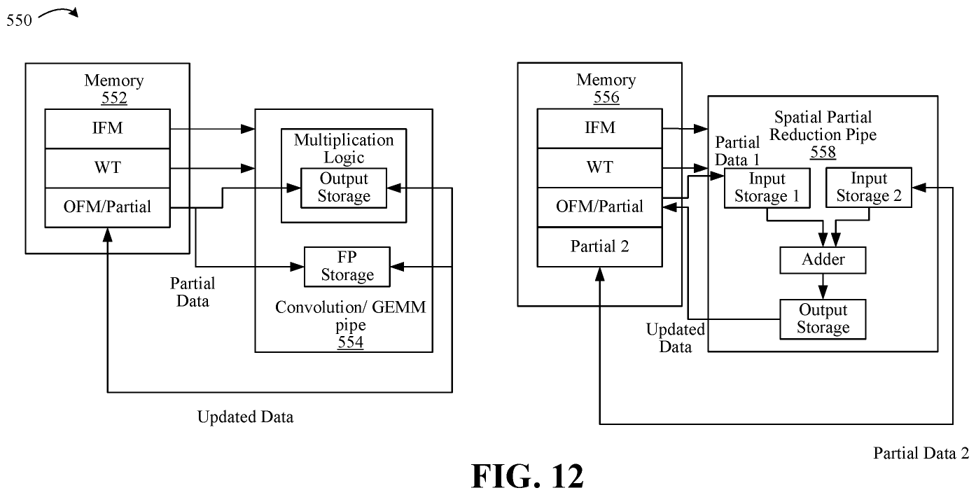

FIG. 12 illustrates a partial reduction architectures 550. The partial reduction architectures 550 may generally be implemented with the embodiments described herein, for example, the multiformat control process 120 (FIG. 1), method 300 (FIG. 2), multiformat architecture 324 (FIG. 3), decomposition and segregation process 330 (FIG. 4), mapping process 360 (FIG. 5), the multiformat processing architecture 380 (FIG. 6), DNN architecture 420 (FIG. 7), systolic multiformat processing architecture 460 (FIG. 8), multiformat controllers (FIG. 9), FP numbers (FIG. 10) and/or LCE 510 (FIG. 11).

In a partial mode, one operand is read from the OFM data region of memory 552 (e.g., memory-array) and accumulated with a convolution result by loading the operand and the convolution result into convolution accumulation registers (e.g., FP storage). The result after accumulation will be written to the OFM region of the memory 552. This operation is performed using convolution/GEMM engine 554.

The spatial partial reduction pipeline 558 reads both operands from the memory 556 (e.g., a memory array). For example, a first operand is read from the partial data region of the memory 556, and a second operand is read from the output data region (e.g., OFM/partial). The computed data after partial reduction is written to the output region (e.g., OFM/partial) of memory 556.

Partial reductions may be element-by-element addition operations to accumulate partial values with the current values. Some embodiments may initiate write operations if none of the other functional blocks (e.g., subsequent operations such as quantization, activation and max pooling blocks) are disabled.

For three precisions which are supported (e.g., 16-bit precision being the highest precision supported) all the intermediate resultants are stored in wider 32-bit registers. Once the compute operation is completed for a given operation, the final resultant is rounded off to the required precision. Doing so reduces the loss of precision which is introduced by rounding off.

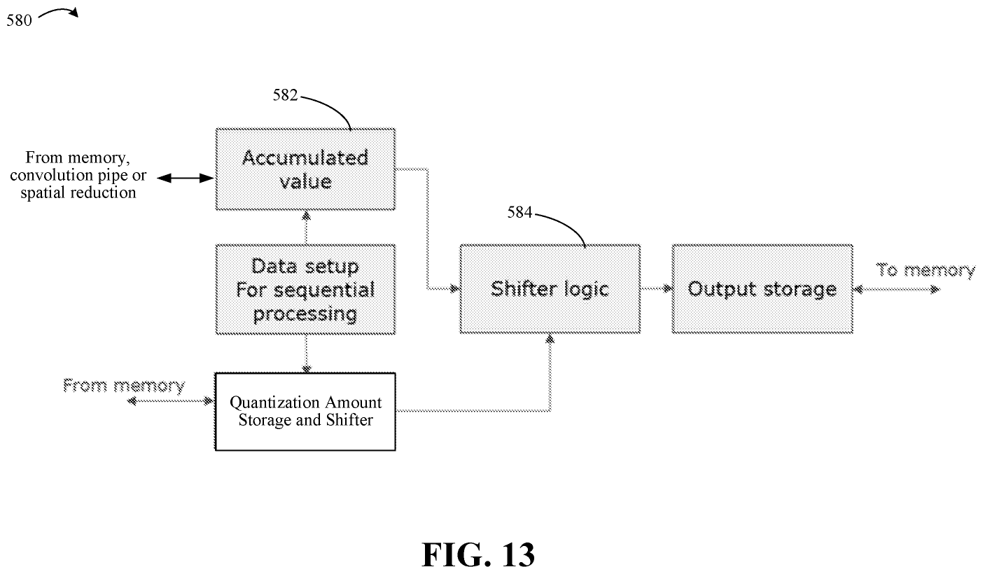

FIG. 13 shows a quantization process 580 that may be executed with a compute engine based on instructions from the multiformat controller. The quantization process 580 may generally be implemented with the embodiments described herein, for example, the multiformat control process 120 (FIG. 1), method 300 (FIG. 2), multiformat architecture 324 (FIG. 3), decomposition and segregation process 330 (FIG. 4), mapping process 360 (FIG. 5), the multiformat processing architecture 380 (FIG. 6), DNN architecture 420 (FIG. 7), systolic multiformat processing architecture 460 (FIG. 8), multiformat controllers (FIG. 9), FP numbers (FIG. 10), LCE 510 (FIG. 11) and/or partial reduction architectures 550 (FIG. 12). The multiformat controller supports channel wise quantization operations. In a quantization operation, the multiformat controller reads the accumulated values 582 (e.g., outputs of different convolution operations) which are accumulated with extended precision and quantize the accumulated values to native precisions of the accumulated values based on the direction provided by the software per channel. Embodiments may populate the channel level quantization value, which may be bits from the accumulated value 582 to be utilized, in the memory at a specific memory location.

The multiformat controller reads the quantization amount and shifts the accumulated inputs in a multi-stage operation with shifter logic 584 in a channel-by-channel basis before writing the output to memory. The multiformat controller assumes that input accumulated values will be always with extended precision. When upstream pipelines are not enabled in such a case, operands to be quantized will be read from the memory along with quantization amount and the operation is performed on a channel-by-channel sequentially. If spatial partial reduction is enabled instead of convolution operation, the multiformat controller will supply the data for quantization if enabled. The multiformat controller initiates write operations if none of the subsequent blocks (activation and max pooling pipe) is/are not enabled.

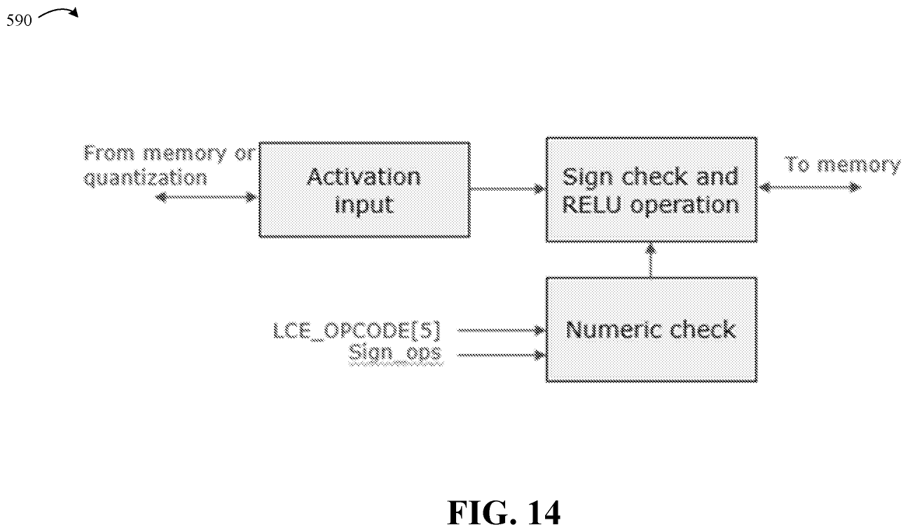

FIG. 14 illustrates operations of an activation pipeline 590. The activation pipeline 590 may generally be implemented with the embodiments described herein, for example, the multiformat control process 120 (FIG. 1), method 300 (FIG. 2), multiformat architecture 324 (FIG. 3), decomposition and segregation process 330 (FIG. 4), mapping process 360 (FIG. 5), the multiformat processing architecture 380 (FIG. 6), DNN architecture 420 (FIG. 7), systolic multiformat processing architecture 460 (FIG. 8), multiformat controllers (FIG. 9), FP numbers (FIG. 10), LCE 510 (FIG. 11), partial reduction architectures 550 (FIG. 12) and/or quantization process 580 (FIG. 13). The multiformat controller supports activation functions (e.g., RELU). The activation pipeline 590 may be programmed as a standalone pipe, or operate in conjunction with a quantization output. The activation pipeline 590 expects the data to be a native precision of the data. Input data may be read from either memory or from a quantization pipe. This activation pipeline 590 will initiate the memory write operations if Max pooling pipe is not enabled.

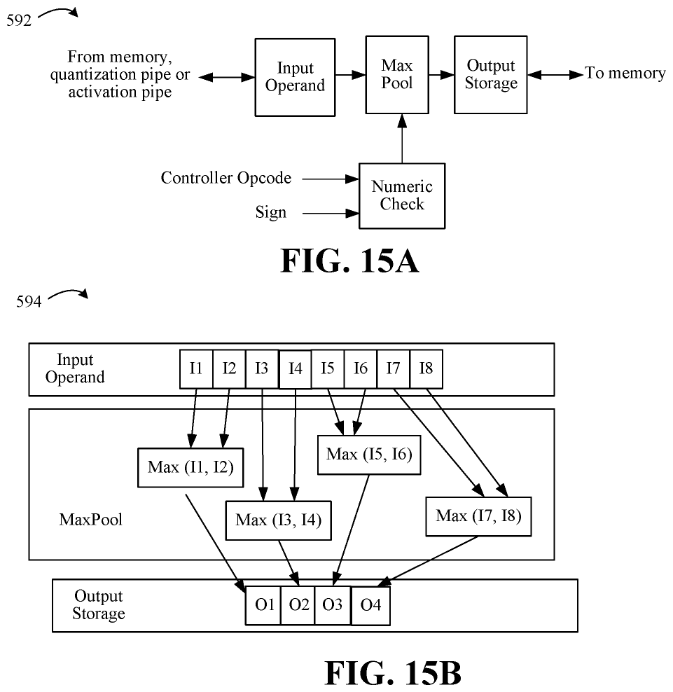

Turning now to FIG. 15A, a Max Pooling pipeline 592 is illustrated. The Max Pooling pipeline 592 may generally be implemented with the embodiments described herein, for example, the multiformat control process 120 (FIG. 1), method 300 (FIG. 2), multiformat architecture 324 (FIG. 3), decomposition and segregation process 330 (FIG. 4), mapping process 360 (FIG. 5), the multiformat processing architecture 380 (FIG. 6), DNN architecture 420 (FIG. 7), systolic multiformat processing architecture 460 (FIG. 8), multiformat controllers (FIG. 9), FP numbers (FIG. 10), LCE 510 (FIG. 11), partial reduction architectures 550 (FIG. 12), quantization process 580 (FIG. 13) and/or activation pipeline 590 (FIG. 14). The Max Pooling pipeline 592 bypasses some components (e.g., multiplier, shifter, etc.) and may be programmed as a standalone pipe or to work with quantization and/or activation function output. This Max Pooling pipeline 592 expects the data to be in a native precision of the data. The multiformat controller may perform max pooling between two subsequent channels. In a case of an application requiring more than two channels to be pooled for maximum, embodiments may process such functionalities with multiple iteration through Max Pooling pipeline 592.

Turning now to FIG. 15B, a Max Pooling process 594 is disclosed. The Max Pooling process 594 may generally be implemented with the embodiments described herein, for example, the multiformat control process 120 (FIG. 1), method 300 (FIG. 2), multiformat architecture 324 (FIG. 3), decomposition and segregation process 330 (FIG. 4), mapping process 360 (FIG. 5), the multiformat processing architecture 380 (FIG. 6), DNN architecture 420 (FIG. 7), systolic multiformat processing architecture 460 (FIG. 8), multiformat controllers (FIG. 9), FP numbers (FIG. 10), LCE 510 (FIG. 11), partial reduction architectures 550 (FIG. 12), quantization process 580 (FIG. 13), activation pipeline 590 (FIG. 14) and/or Max Pooling pipeline 592 (FIG. 15A). An input operand is provided to MaxPool, which then generates output O1, O2, O3, O4. The output O1, O2, O3, O4 may be stored in output storage

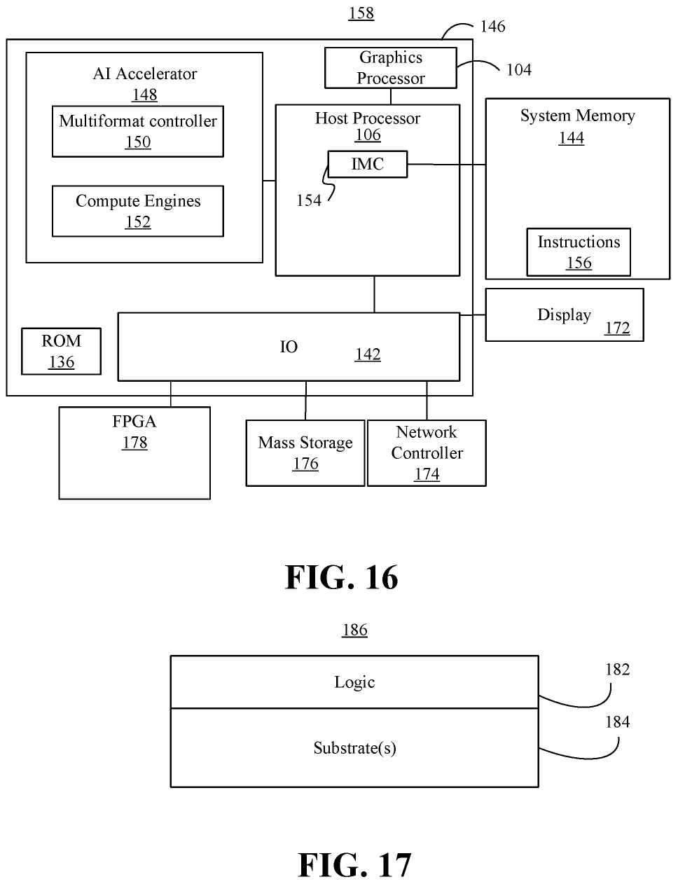

Turning now to FIG. 16, an efficiency-enhanced and performance-enhanced multiformat computing system 158 is shown. The computing system 158 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), edge device (e.g., mobile phone, desktop, etc.) etc., or any combination thereof. In the illustrated example, the computing system 158 includes a host processor 106 (e.g., CPU) having an integrated memory controller (IMC) 154 that is coupled to a system memory 144.

The illustrated computing system 158 also includes an input output (TO) module 142 implemented together with the host processor 106, the graphics processor 104 (e.g., GPU), ROM 136, and AI accelerator 148 on a semiconductor die 146 as a system on chip (SoC). The illustrated IO module 142 communicates with, for example, a display 172 (e.g., touch screen, liquid crystal display/LCD, light emitting diode/LED display), a network controller 174 (e.g., wired and/or wireless), FPGA 178 and mass storage 176 (e.g., hard disk drive/HDD, optical disk, solid state drive/SSD, flash memory). The SoC 146 may further include processors (not shown) and/or the AI accelerator 148 dedicated to artificial intelligence (AI) and/or neural network (NN) processing. For example, the system SoC 146 may include vision processing units (VPUs,) and/or other AI/NN-specific processors such as AI accelerator 148, etc. In some embodiments, any aspect of the embodiments described herein may be implemented in the processors, such as the graphics processor 104 and/or the host processor 106, and in the accelerators dedicated to AI and/or NN processing such as AI accelerator 148 or other devices such as the FPGA 178.

The graphics processor 104, AI accelerator 148 and/or the host processor 106 may execute instructions 156 retrieved from the system memory 144 (e.g., a dynamic random-access memory) and/or the mass storage 176 to implement aspects as described herein. For example, multiformat controller 150 may determine whether an operation is a floating-point based computation or an integer-based computation. When the operation is the floating-point based computation, the multiformat controller 150 generates a map of the operation to compute engines 152 (which may be integer-based) to control the compute engines 152 to execute the floating-point based computation. When the operation is the integer-based computation, the multiformat controller 150 controls the compute engines 152 to execute the integer-based computation

When the instructions 156 are executed, the computing system 158 may implement one or more aspects of the embodiments described herein. For example, the computing system 158 may implement one or more aspects of the multiformat control process 120 (FIG. 1), method 300 (FIG. 2), multiformat architecture 324 (FIG. 3), decomposition and segregation process 330 (FIG. 4), mapping process 360 (FIG. 5), the multiformat processing architecture 380 (FIG. 6), DNN architecture 420 (FIG. 7), systolic multiformat processing architecture 460 (FIG. 8), multiformat controllers (FIG. 9), FP numbers (FIG. 10), LCE 510 (FIG. 11), partial reduction architectures 550 (FIG. 12), quantization process 580 (FIG. 13), activation pipeline 590 (FIG. 14), Max Pooling pipeline 592 (FIG. 15A), and/or Max Pooling process 594 (FIG. 15B), already discussed. The illustrated computing system 158 is therefore considered to be an efficiency-enhanced and hardware-enhanced at least to the extent that the computing system 158 reduces and latency and energy to execute integer and FP operations, while also reducing the area of the AI accelerator 148.

FIG. 17 shows a semiconductor apparatus 186 (e.g., chip, die, package). The illustrated apparatus 186 includes one or more substrates 184 (e.g., silicon, sapphire, gallium arsenide) and logic 182 (e.g., transistor array and other integrated circuit/IC components) coupled to the substrate(s) 184. In an embodiment, the apparatus 186 is operated in an application development stage and the logic 182 performs one or more aspects of the embodiments described herein, for example, The apparatus 186 may generally implement the embodiments described herein, for example, multiformat control process 120 (FIG. 1), method 300 (FIG. 2), multiformat architecture 324 (FIG. 3), decomposition and segregation process 330 (FIG. 4), mapping process 360 (FIG. 5), the multiformat processing architecture 380 (FIG. 6), DNN architecture 420 (FIG. 7), systolic multiformat processing architecture 460 (FIG. 8), multiformat controllers (FIG. 9), FP numbers (FIG. 10), LCE 510 (FIG. 11), partial reduction architectures 550 (FIG. 12), quantization process 580 (FIG. 13), activation pipeline 590 (FIG. 14), Max Pooling pipeline 592 (FIG. 15A), and/or Max Pooling process 594 (FIG. 15B), already discussed. The logic 182 may be implemented at least partly in configurable logic or fixed-functionality hardware logic. In one example, the logic 182 includes transistor channel regions that are positioned (e.g., embedded) within the substrate(s) 184. Thus, the interface between the logic 182 and the substrate(s) 184 may not be an abrupt junction. The logic 182 may also be considered to include an epitaxial layer that is grown on an initial wafer of the substrate(s) 184.

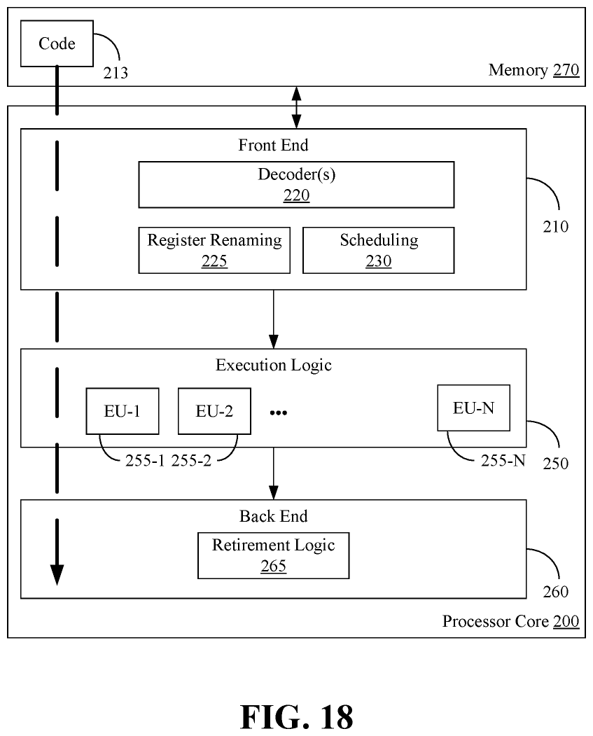

FIG. 18 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 18, a processing element may alternatively include more than one of the processor core 200 illustrated in FIG. 8. The processor core 200 may be a single-threaded core or, for at least one embodiment, the processor core 200 may be multithreaded in that it may include more than one hardware thread context (or “logical processor”) per core.

FIG. 18 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement one or more aspects of the embodiments such as, for example, the multiformat control process 120 (FIG. 1), method 300 (FIG. 2), multiformat architecture 324 (FIG. 3), decomposition and segregation process 330 (FIG. 4), mapping process 360 (FIG. 5), the multiformat processing architecture 380 (FIG. 6), DNN architecture 420 (FIG. 7), systolic multiformat processing architecture 460 (FIG. 8), multiformat controllers (FIG. 9), FP numbers (FIG. 10), LCE 510 (FIG. 11), partial reduction architectures 550 (FIG. 12), quantization process 580 (FIG. 13), activation pipeline 590 (FIG. 14), Max Pooling pipeline 592 (FIG. 15A), and/or Max Pooling process 594 (FIG. 15B), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include several execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back-end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 18, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

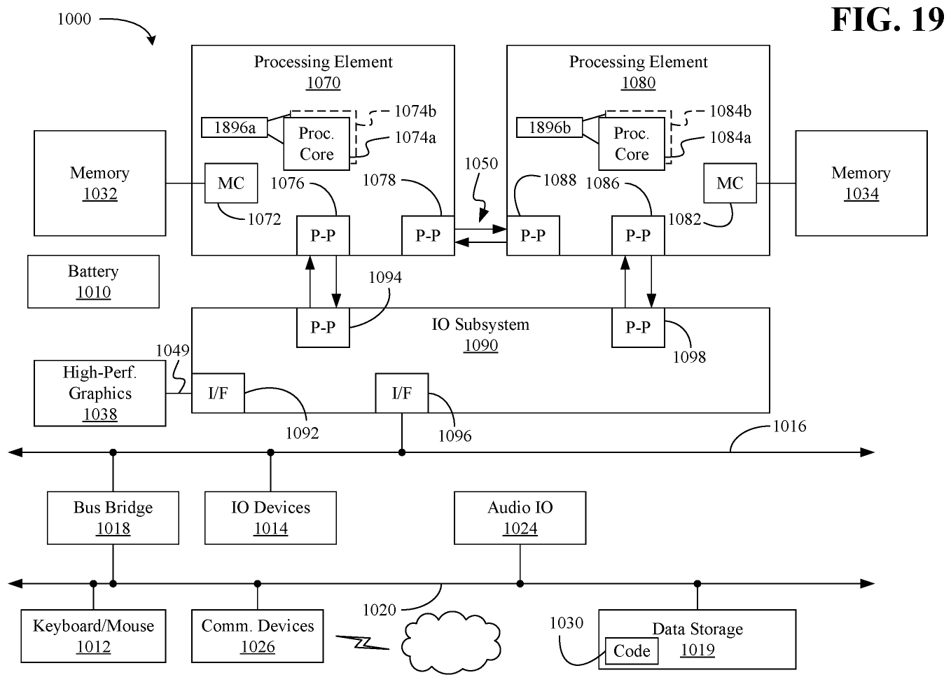

Referring now to FIG. 19, shown is a block diagram of a computing system 1000 embodiment in accordance with an embodiment. Shown in FIG. 19 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood any or all the interconnects illustrated in FIG. 19 may be implemented as a multi-drop bus rather than point-to-point interconnect.

As shown in FIG. 19, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner like that discussed above in connection with FIG. 18.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof

While shown with only two processing elements 1070, 1080, it is to be understood that the scope of the embodiments is not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 19, MC' s 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 19, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments is not so limited.

As shown in FIG. 19, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the one or more aspects of such as, for example, multiformat control process 120 (FIG. 1), method 300 (FIG. 2), multiformat architecture 324 (FIG. 3), decomposition and segregation process 330 (FIG. 4), mapping process 360 (FIG. 5), the multiformat processing architecture 380 (FIG. 6), DNN architecture 420 (FIG. 7), systolic multiformat processing architecture 460 (FIG. 8), multiformat controllers (FIG. 9), FP numbers (FIG. 10), LCE 510 (FIG. 11), partial reduction architectures 550 (FIG. 12), quantization process 580 (FIG. 13), activation pipeline 590 (FIG. 14), Max Pooling pipeline 592 (FIG. 15A), and/or Max Pooling process 594 (FIG. 15B), already discussed. Further, an audio I/O 1024 may be coupled to second bus 1020 and a battery 1010 may supply power to the computing system 1000.

Note that other embodiments are contemplated. For example, instead of the point-to-point architecture of FIG. 19, a system may implement a multi-drop bus or another such communication topology. Also, the elements of FIG. 19 may alternatively be partitioned using more or fewer integrated chips than shown in FIG. 19.

Additional Notes and Examples:

Example 1 includes a computing system comprising a plurality of computational engines implemented in one or more of configurable logic or fixed-functionality logic hardware, wherein the computational engines includes integer-based compute engines, a controller implemented in one or more of configurable logic or fixed-functionality logic hardware, wherein the controller is to determine whether an operation is a floating-point based computation or an integer-based computation, when the operation is the floating-point based computation, generate a map of the operation to the integer-based compute engines to control the integer-based compute engines to execute the floating-point based computation, and when the operation is the integer-based computation, control the integer-based compute engines to execute the integer-based computation.

Example 2 includes the computing system of Example 1, wherein controller is to generate the map through a division of a floating-point number associated with the floating-point based computation into a plurality of portions, and an assignment of each of the plurality of portions to a different integer-based compute engine of the integer-based compute engines.

Example 3 includes the computing system of Example 2, wherein the plurality of portions includes a sign portion, an exponent portion and a mantissa portion, the controller is to store the sign portion into a sign register, the exponent portion into an exponent register and the mantissa portion into a mantissa register, and the plurality of computational engines includes floating-point compute engines.

Example 4 includes the computing system of any one of Examples 1 to 3, wherein the controller is to identify weight data associated with the operation, wherein the weight data has a first number of dimensions, adjust the weight data to increase the first number of dimensions to a second number of dimensions, store the weight data having the second number of dimensions in a tile-based fashion to a memory, and store input features associated with the operation and output features associated with the operation to the memory in the tile-based fashion.

Example 5 includes the computing system of any one of Examples 1 to 4, wherein the operation is associated with a deep neural network workload.

Example 6 includes the computing system of any one of Examples 1 to 5, wherein the integer-based compute engines are to execute one or more of partial reduction operations, quantization shifter operations, activation function operations or max pooling operations.

Example 7 includes the computing system of any one of Examples 1 to 6, wherein the map is to include a finite state machine, wherein the controller is to control a flow of data during the operation to the integer-based compute engines based on the finite state machine.

Example 8 includes the computing system of any one of Examples 1 to 7, wherein the operation is the floating-point based computation and is associated with first and second floating-point numbers, wherein the map is to include one or more of an assignment of sign elements of the first and second floating-point numbers to an XOR gate of the integer-based compute engines, an assignment of exponent elements of the first and second floating-point numbers to an adder of the integer-based compute engines, and an assignment of mantissa elements of the first and second floating-point numbers to a multiplier of the integer-based compute engines.

Example 9 includes a semiconductor apparatus comprising one or more substrates, and logic coupled to the one or more substrates, wherein the logic is implemented in one or more of configurable logic or fixed-functionality logic hardware, the logic coupled to the one or more substrates to determine whether an operation is a floating-point based computation or an integer-based computation, when the operation is the floating-point based computation, generate a map of the operation to integer-based compute engines to control the integer-based compute engines to execute the floating-point based computation, and when the operation is the integer-based computation, control the integer-based compute engines to execute the integer-based computation.

Example 10 includes the apparatus of Example 9, wherein the logic is to generate the map through a division of a floating-point number associated with the floating-point based computation into a plurality of portions, and an assignment of each of the plurality of portions to a different integer-based compute engine of the integer-based compute engines.

Example 11 includes the apparatus of Example 10, wherein the plurality of portions includes a sign portion, an exponent portion and a mantissa portion, and the logic coupled to the one or more substrates is to store the sign portion into a sign register, the exponent portion into an exponent register and the mantissa portion into a mantissa register.

Example 12 includes the apparatus of any one of Examples 9 to 11, wherein the logic coupled to the one or more substrates is to identify weight data associated with the operation, wherein the weight data has a first number of dimensions, adjust the weight data to increase the first number of dimensions to a second number of dimensions, store the weight data having the second number of dimensions in a tile-based fashion to a memory, and store input features associated with the operation and output features associated with the operation to the memory in the tile-based fashion.

Example 13 includes the apparatus of any one of Examples 9 to 12, wherein the operation is associated with a deep neural network workload.

Example 14 includes the apparatus of any one of Examples 9 to 13, wherein the integer-based compute engines are to execute one or more of partial reduction operations, quantization shifter operations, activation function operations or max pooling operations.

Example 15 includes the apparatus of any one of Examples 9 to 14, wherein the map is to include a finite state machine, and the logic coupled to the one or more substrates is to control a flow of data to the integer-based compute engines based on the finite state machine, wherein the data is associated with the operation.

Example 16 includes the apparatus of any one of Examples 9 to 15, wherein the operation is the floating-point based computation and is associated with first and second floating-point numbers, further wherein the map is to include one or more of an assignment of sign elements of the first and second floating-point numbers to an XOR gate of the integer-based compute engines, an assignment of exponent elements of the first and second floating-point numbers to an adder of the integer-based compute engines, and an assignment of mantissa elements of the first and second floating-point numbers to a multiplier of the integer-based compute engines.

Example 17 includes the apparatus of any one of Examples 9 to 16, wherein the logic coupled to the one or more substrates includes transistor channel regions that are positioned within the one or more substrates.

Example 18 includes a method comprising determining whether an operation is a floating-point based computation or an integer-based computation, when the operation is the floating-point based computation, generating a map of the operation to integer-based compute engines to control the integer-based compute engines to execute the floating-point based computation, and when the operation is the integer-based computation, controlling the integer-based compute engines to execute the integer-based computation.

Example 19 includes the method of Example 18, wherein the generating the map comprises dividing a floating-point number associated with the floating-point based computation into a plurality of portions, and assigning each of the plurality of portions to a different integer-based compute engine of the integer-based compute engines.

Example 20 includes the method of Example 19, wherein the plurality of portions includes a sign portion, an exponent portion and a mantissa portion, and the method further comprises storing the sign portion into a sign register, the exponent portion into an exponent register and the mantissa portion into a mantissa register.

Example 21 includes the method of any one of Examples 18 to 20, further comprising identifying weight data associated with the operation, wherein the weight data has a first number of dimensions, adjusting the weight data to increase the first number of dimensions to a second number of dimensions, storing the weight data having the second number of dimensions in a tile-based fashion to a memory, and storing input features associated with the operation and output features associated with the operation to the memory in the tile-based fashion.

Example 22 includes the method of any one of Examples 18 to 21, wherein the operation is associated with a deep neural network workload.

Example 23 includes the method of any one of Examples 18 to 22, wherein the integer-based compute engines execute one or more of partial reduction operations, quantization shifter operations, activation function operations or max pooling operations.

Example 24 includes the method of Example any one of Examples 18 to 23, wherein the map includes a finite state machine, and the method further comprises controlling a flow of data to the integer-based compute engines based on the finite state machine, wherein the data is associated with the operation.

Example 25 includes the method of any one of Examples 18 to 24, wherein the operation is the floating-point based computation and is associated with first and second floating-point numbers, further wherein the map includes one or more of an assignment of sign elements of the first and second floating-point numbers to an XOR gate of the integer-based compute engines, an assignment of exponent elements of the first and second floating-point numbers to an adder of the integer-based compute engines, and an assignment of mantissa elements of the first and second floating-point numbers to a multiplier of the integer-based compute engines.

Example 26 includes an apparatus comprising means for determining whether an operation is a floating-point based computation or an integer-based computation, when the operation is the floating-point based computation, means for generating a map of the operation to integer-based compute engines to control the integer-based compute engines to execute the floating-point based computation, and when the operation is the integer-based computation, means for controlling the integer-based compute engines to execute the integer-based computation.

Example 27 includes the apparatus of Example 26, wherein the means for generating the map comprises means for dividing a floating-point number associated with the floating-point based computation into a plurality of portions, and means for assigning each of the plurality of portions to a different integer-based compute engine of the integer-based compute engines.

Example 28 includes the apparatus of Example 27, wherein the plurality of portions includes a sign portion, an exponent portion and a mantissa portion, and the apparatus further comprises means for storing the sign portion into a sign register, the exponent portion into an exponent register and the mantissa portion into a mantissa register.

Example 29 includes the apparatus of any one of Examples 26 to 28, further comprising means for identifying weight data associated with the operation, wherein the weight data has a first number of dimensions, means for adjusting the weight data to increase the first number of dimensions to a second number of dimensions, means for storing the weight data having the second number of dimensions in a tile-based fashion to a memory, and means for storing input features associated with the operation and output features associated with the operation to the memory in the tile-based fashion.

Example 30 includes apparatus of any one of Examples 26 to 29, wherein the operation is associated with a deep neural network workload.

Example 31 includes the apparatus of any one of Examples 26 to 30, wherein the integer-based compute engines execute one or more of partial reduction operations, quantization shifter operations, activation function operations or max pooling operations.

Example 32 includes the apparatus of any one of Examples 26 to 31, wherein the map includes a finite state machine, and the apparatus further comprises means for controlling a flow of data to the integer-based compute engines based on the finite state machine, wherein the data is to be associated with the operation.

Example 33 includes the apparatus of any one of Examples 26 to 32, wherein the operation is to include the floating-point based computation and is associated with first and second floating-point numbers, further wherein the map includes one or more of an assignment of sign elements of the first and second floating-point numbers to an XOR gate of the integer-based compute engines, an assignment of exponent elements of the first and second floating-point numbers to an adder of the integer-based compute engines, and an assignment of mantissa elements of the first and second floating-point numbers to a multiplier of the integer-based compute engines.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical, or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a plurality of computational engines implemented in one or more of configurable logic or fixed-functionality logic hardware, wherein the computational engines includes integer-based compute engines;
a controller implemented in one or more of configurable logic or fixed-functionality logic hardware, wherein the controller is to:
determine whether an operation is a floating-point based computation or an integer-based computation,
when the operation is the floating-point based computation, generate a map of the operation to the integer-based compute engines to control the integer-based compute engines to execute the floating-point based computation, and
when the operation is the integer-based computation, control the integer-based compute engines to execute the integer-based computation.

2. The computing system of claim 1, wherein controller is to generate the map through:
a division of a floating-point number associated with the floating-point based computation into a plurality of portions; and
an assignment of each of the plurality of portions to a different integer-based compute engine of the integer-based compute engines.

3. The computing system of claim 2, wherein:
the plurality of portions includes a sign portion, an exponent portion and a mantissa portion,
the controller is to store the sign portion into a sign register, the exponent portion into an exponent register and the mantissa portion into a mantissa register, and
the plurality of computational engines includes floating-point compute engines.

4. The computing system of claim 1, wherein the controller is to:
identify weight data associated with the operation, wherein the weight data has a first number of dimensions;
adjust the weight data to increase the first number of dimensions to a second number of dimensions;
store the weight data having the second number of dimensions in a tile-based fashion to a memory; and
store input features associated with the operation and output features associated with the operation to the memory in the tile-based fashion.

5. The computing system of claim 1, wherein the operation is associated with a deep neural network workload.

6. The computing system of claim 1, wherein the integer-based compute engines are to execute one or more of partial reduction operations, quantization shifter operations, activation function operations or max pooling operations.

7. The computing system of claim 1, wherein the map is to include a finite state machine,
wherein the controller is to control a flow of data during the operation to the integer-based compute engines based on the finite state machine.

8. The computing system of claim 1, wherein the operation is the floating-point based computation and is associated with first and second floating-point numbers, wherein the map is to include one or more of:
an assignment of sign elements of the first and second floating-point numbers to an XOR gate of the integer-based compute engines;
an assignment of exponent elements of the first and second floating-point numbers to an adder of the integer-based compute engines; and
an assignment of mantissa elements of the first and second floating-point numbers to a multiplier of the integer-based compute engines.

9. A semiconductor apparatus comprising:
one or more substrates; and
logic coupled to the one or more substrates, wherein the logic is implemented in one or more of configurable logic or fixed-functionality logic hardware, the logic coupled to the one or more substrates to:
determine whether an operation is a floating-point based computation or an integer-based computation,
when the operation is the floating-point based computation, generate a map of the operation to integer-based compute engines to control the integer-based compute engines to execute the floating-point based computation, and
when the operation is the integer-based computation, control the integer-based compute engines to execute the integer-based computation.

10. The apparatus of claim 9, wherein the logic is to generate the map through:
a division of a floating-point number associated with the floating-point based computation into a plurality of portions; and
an assignment of each of the plurality of portions to a different integer-based compute engine of the integer-based compute engines.

11. The apparatus of claim 10, wherein:
the plurality of portions includes a sign portion, an exponent portion and a mantissa portion, and
the logic coupled to the one or more substrates is to store the sign portion into a sign register, the exponent portion into an exponent register and the mantissa portion into a mantissa register.

12. The apparatus of claim 9, wherein the logic coupled to the one or more substrates is to:
identify weight data associated with the operation, wherein the weight data has a first number of dimensions;
adjust the weight data to increase the first number of dimensions to a second number of dimensions;
store the weight data having the second number of dimensions in a tile-based fashion to a memory; and
store input features associated with the operation and output features associated with the operation to the memory in the tile-based fashion.

13. The apparatus of claim 9, wherein the operation is associated with a deep neural network workload.

14. The apparatus of claim 9, wherein the integer-based compute engines are to execute one or more of partial reduction operations, quantization shifter operations, activation function operations or max pooling operations.

15. The apparatus of claim 9, wherein:
the map is to include a finite state machine, and
the logic coupled to the one or more substrates is to control a flow of data to the integer-based compute engines based on the finite state machine, wherein the data is associated with the operation.

16. The apparatus of claim 9, wherein the operation is the floating-point based computation and is associated with first and second floating-point numbers, further wherein the map is to include one or more of:
an assignment of sign elements of the first and second floating-point numbers to an XOR gate of the integer-based compute engines;
an assignment of exponent elements of the first and second floating-point numbers to an adder of the integer-based compute engines; and
an assignment of mantissa elements of the first and second floating-point numbers to a multiplier of the integer-based compute engines.

17. The apparatus of claim 9, wherein the logic coupled to the one or more substrates includes transistor channel regions that are positioned within the one or more substrates.

18. A method comprising:
determining whether an operation is a floating-point based computation or an integer-based computation;
when the operation is the floating-point based computation, generating a map of the operation to integer-based compute engines to control the integer-based compute engines to execute the floating-point based computation; and
when the operation is the integer-based computation, controlling the integer-based compute engines to execute the integer-based computation.

19. The method of claim 18, wherein the generating the map comprises:
dividing a floating-point number associated with the floating-point based computation into a plurality of portions; and
assigning each of the plurality of portions to a different integer-based compute engine of the integer-based compute engines.

20. The method of claim 19, wherein:
the plurality of portions includes a sign portion, an exponent portion and a mantissa portion, and
the method further comprises storing the sign portion into a sign register, the exponent portion into an exponent register and the mantissa portion into a mantissa register.

21. The method of claim 18, further comprising:
identifying weight data associated with the operation, wherein the weight data has a first number of dimensions;
adjusting the weight data to increase the first number of dimensions to a second number of dimensions;
storing the weight data having the second number of dimensions in a tile-based fashion to a memory; and
storing input features associated with the operation and output features associated with the operation to the memory in the tile-based fashion.

22. The method of claim 18, wherein the operation is associated with a deep neural network workload.

23. The method of claim 18, wherein the integer-based compute engines execute one or more of partial reduction operations, quantization shifter operations, activation function operations or max pooling operations.

24. The method of claim 18, wherein:
the map includes a finite state machine, and
the method further comprises controlling a flow of data to the integer-based compute engines based on the finite state machine, wherein the data is associated with the operation.

25. The method of claim 18, wherein the operation is the floating-point based computation and is associated with first and second floating-point numbers, further wherein the map includes one or more of:
an assignment of sign elements of the first and second floating-point numbers to an XOR gate of the integer-based compute engines;
an assignment of exponent elements of the first and second floating-point numbers to an adder of the integer-based compute engines; and
an assignment of mantissa elements of the first and second floating-point numbers to a multiplier of the integer-based compute engines.
